(19) United States
(12) Patent Application Publication
(10) Pub. No.: US 2023/0294426 A1
(43) Pub. Date: Sep. 21, 2023

(54) PRINTING APPARATUS AND CONTROL METHOD THEREOF, AND STORAGE MEDIUM

(71) Applicant: CANON KABUSHIKI KAISHA, Tokyo (JP)

(72) Inventors: Noriyuki Sugiyama, Kanagawa (JP); MOTOYUKI TAGUCHI, Tokyo (JP); Junichi Kubokawa, Nagasaki (JP); YASUNORI MATSUMOTO, Kanagawa (JP); YUMI MUKOYAMA, Tokyo (JP); MASAAKI MATSUURA, Kanagawa (JP); TAKAHIRO KIUCHI, Tokyo (JP); KEISEI HAKAMATA, Kanagawa (JP); Haruo Uchida, Kanagawa (JP); Shoichi Kan, Kanagawa (JP); TAKAAKI ISHIDA, Kanagawa (JP); KYOSUKE KAMISHIMA, Kanagawa (JP)

(21) Appl. No.: 18/122,348

(22) Filed: Mar. 16, 2023

(30) Foreign Application Priority Data
Mar. 17, 2022 (JP) 2022-042778

(51) Int. Cl. B41J 13/00

(52) U.S. Cl. CPC B41J 13/0045

(57) ABSTRACT

A printing apparatus includes a supply unit configured to supply a print medium, an intermediate roller configured to transport the print medium, a transport roller configured to transport the print medium, a printing unit configured to print an image on the print medium, a reversing path configured to return, to the intermediate roller, the print medium which has been reversed front to back, and a control unit capable of first control for causing a second print medium supplied from the supply unit to overlap a first print medium being printed onto by the printing unit, and second control for causing a second print medium transported from the reversing path to overlap the first print medium being printed onto by the printing unit.

### BACKGROUND OF THE INVENTION

### Field of the Invention

The present invention relates to a printing apparatus capable of double-sided printing by automatically reversing a print medium from a first surface to a second surface.

### Description of the Related Art

Japanese Patent Laid-Open No. 2017-052614 discloses a printing apparatus that sequentially performs control for causing a leading end, in a transport direction, of a following print medium, which is fed from a paper loading unit after a preceding print medium, to overlap the preceding print medium which has been reversed by a reversing means after a first surface thereof is printed.

However, the apparatus described in Japanese Patent Laid-Open No. 2017-052614 performs control for causing part of the following print medium to overlap the preceding print medium only when the print medium is fed from the paper loading unit. There has thus been a technical issue in that the following print medium cannot be caused to overlap the preceding print medium in a continuous manner, and it therefore takes time before the print medium is fed to a printing area opposite the print head.

### SUMMARY OF THE INVENTION

Having been achieved in light of the foregoing issue, the present invention provides a printing apparatus capable of shortening the time required to feed a print medium to a printing area opposite a print head.

According to a first aspect of the present invention, there is provided a printing apparatus comprising: a supply unit configured to supply a print medium; an intermediate roller configured to transport the print medium supplied by the supply unit; a transport roller configured to transport, in a transport direction, the print medium transported by the intermediate roller; a printing unit configured to print an image on the print medium transported by the transport roller, downstream from the transport roller; a reversing path configured to return, to the intermediate roller, the print medium which has been printed onto by the printing unit and which has been reversed front to back; and a control unit capable of: first control for causing a second print medium supplied from the supply unit to overlap a first print medium being printed onto by the printing unit, between the intermediate roller and the transport roller, and second control for causing a second print medium transported from the reversing path to overlap the first print medium being printed onto by the printing unit, between the intermediate roller and the transport roller.

According to a second aspect of the present invention, there is provided a control method for controlling a printing apparatus, the printing apparatus comprising: a supply unit configured to supply a print medium: an intermediate roller configured to transport the print medium supplied by the supply unit; a transport roller configured to transport, in a transport direction, the print medium transported by the intermediate roller; a printing unit configured to print an image on the print medium transported by the transport roller, downstream from the transport roller; and a reversing path configured to return, to the intermediate roller, the print medium which has been printed onto by the printing unit and which has been reversed front to back, and the control method comprising performing control capable of: causing a second print medium supplied from the supply unit to overlap a first print medium being printed onto by the printing unit, between the intermediate roller and the transport roller, and causing a second print medium transported from the reversing path to overlap the first print medium being printed onto by the printing unit, between the intermediate roller and the transport roller.

Further features of the present invention will become apparent from the following description of exemplary embodiments with reference to the attached drawings.

### BRIEF DESCRIPTION OF THE DRAWINGS

FIG. 1 is a cross-sectional view of the main parts of a printing apparatus according to one embodiment of the present invention.

FIG. 2 is a diagram illustrating overlapping continuous feeding in a printing apparatus according to one embodiment of the present invention.

FIG. 3 is a diagram illustrating overlapping continuous feeding in a printing apparatus according to one embodiment of the present invention.

FIG. 4 is a diagram illustrating overlapping continuous feeding in a printing apparatus according to one embodiment of the present invention.

FIG. 5 is a diagram illustrating overlapping continuous feeding in a printing apparatus according to one embodiment of the present invention.

FIG. 6 is a diagram illustrating overlapping continuous feeding in a printing apparatus according to one embodiment of the present invention.

FIG. 7 is a diagram illustrating overlapping continuous feeding in a printing apparatus according to one embodiment of the present invention.

FIG. 8 is a diagram illustrating overlapping continuous feeding in a printing apparatus according to one embodiment of the present invention.

FIG. 9 is a diagram illustrating overlapping continuous feeding in a printing apparatus according to one embodiment of the present invention.

FIG. 10 is a diagram illustrating overlapping continuous feeding in a printing apparatus according to one embodiment of the present invention.

FIG. 11 is a diagram illustrating overlapping continuous feeding in a printing apparatus according to one embodiment of the present invention.

FIG. 12 is a flowchart illustrating overlapping continuous feed operations according to one embodiment.

FIG. 13 is a flowchart illustrating overlapping continuous feed operations according to one embodiment.

FIG. 14 is a flowchart illustrating overlapping continuous feed operations according to one embodiment.

FIG. 15 is a flowchart illustrating overlapping continuous feed operations according to one embodiment.

FIG. 16 is a flowchart illustrating overlapping continuous feed operations according to one embodiment.

FIG. 17 is a flowchart illustrating overlapping continuous feed operations according to one embodiment.

FIGS. 18A and 18B are flowcharts illustrating overlapping continuous feed operations according to one embodiment.

FIG. 19 is a block diagram illustrating a printing apparatus according to one embodiment.

FIGS. 20A and 20B are diagrams illustrating the configuration of a pickup roller.

FIG. 21 is a diagram illustrating operations for causing a following sheet to overlap with a leading sheet.

FIG. 22 is a diagram illustrating operations for causing a following sheet to overlap with a leading sheet.

FIG. 23 is a flowchart illustrating skew correction operations for a following sheet according to one embodiment.

FIG. 24 is a flowchart illustrating operations for calculating a leading end position for a following sheet.

FIG. 25 is a diagram illustrating a printing area for a first surface of a print medium P according to one embodiment.

FIG. 26 is a diagram illustrating a printing determination state for a first surface of a print medium P according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

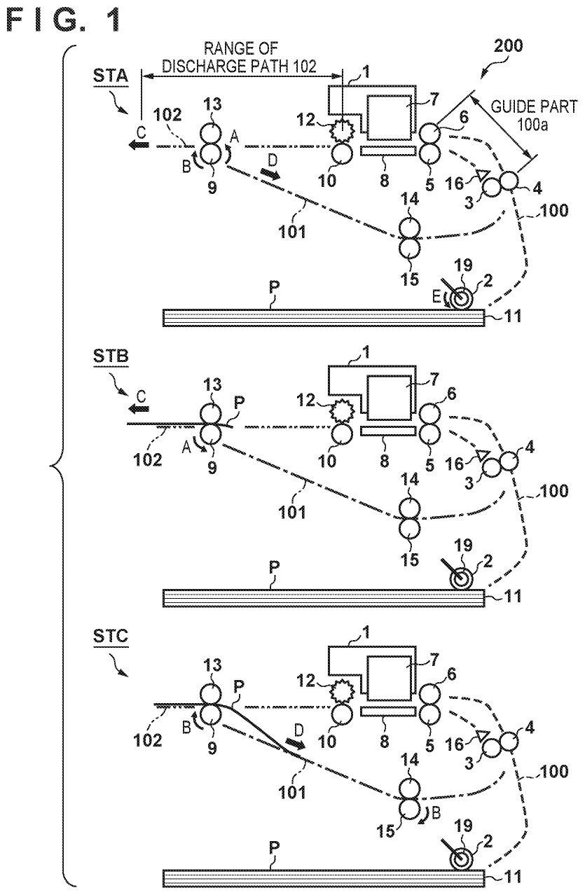

FIG. 1 is a cross-sectional view illustrating the main parts of a printing apparatus 200 according to one embodiment of the present invention. The overall configuration of the printing apparatus 200 according to the present embodiment will be described using the drawings indicated by STA to STC in FIG. 1.

In STA in FIG. 1, P indicates a print medium. A plurality of sheets of the print medium P are loaded in a paper loading unit 11. 2 indicates a pickup roller which makes contact with the topmost print medium P loaded in the paper loading unit 11 to pick up that print medium. 3 indicates a feed roller for feeding the print medium P picked up by the pickup roller 2 downstream in a transport direction along a first transport path 100. 4 indicates a feed driven roller which is biased against the feed roller 3 and feeds the print medium P by pinching the print medium P with the feed roller 3. Note that a part of the first transport path 100 that guides the print medium P between the feed roller 3 and a transport roller 5 (described below) will be called a “guide part 100a”.

5 indicates the transport roller, which transports the print medium P fed by the feed roller 3 and the feed driven roller 4 to a position opposite a print head 7. 6 indicates a pinch roller which is biased against the transport roller 5 and which transports the print medium P by pinching the print medium P with the transport roller 5.

7 indicates the print head, which prints onto the print medium P transported by the transport roller 5 and the pinch roller 6. The present embodiment will describe the print head 7 as having an ink jet print head which prints onto the print medium P by ejecting ink. 8 indicates a platen that supports a second surface (a back surface) of the print medium P at a position opposite the print head 7. 1 indicates a carriage on which the print head 7 is mounted and which moves in a direction that intersects with the print medium transport direction.

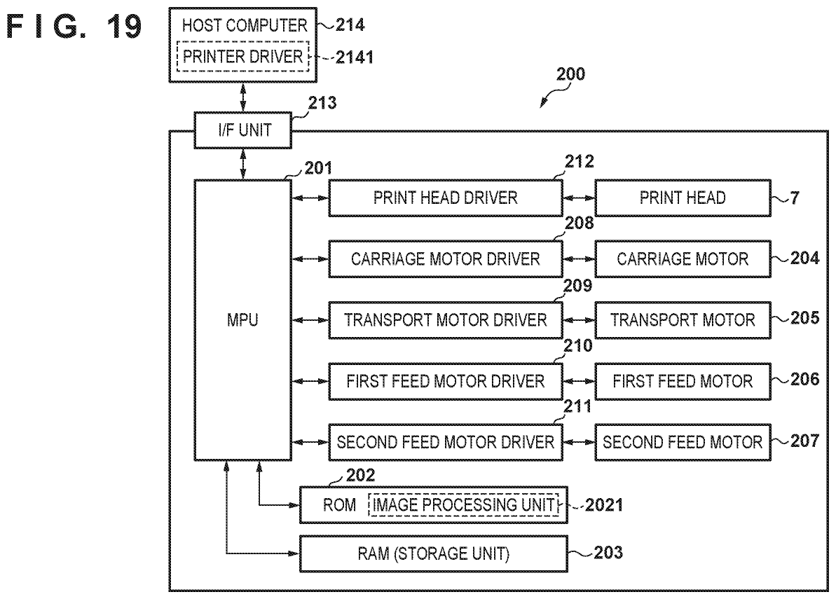

9 indicates a reversing roller which is capable of rotating in the direction of the arrow A (forward rotation) in STA in FIG. 1 by a second feed motor 207 (see FIG. 19) driving forward, and which can transport the print medium P, which has been printed onto by the print head 7, in the direction of the arrow C. The reversing roller 9 can discharge the print medium P outside the apparatus as indicated by the arrow C. Note that a part that guides the discharge of the print medium P from a discharge roller 10 (described below) to the downstream side of the reversing roller 9 in the transport direction will be called a “discharge path 102”.

Additionally, as indicated by STB in FIG. 1, the second feed motor 207 drives in reverse after the print medium P is transported in the direction of the arrow C in STB in FIG. 1 and an upstream-side end part of the print medium P in the transport direction reaches the vicinity of the reversing roller 9. As a result, the reversing roller 9 rotates in the direction of the arrow B in STC in FIG. 1 (rotates in the opposite direction), and the print medium P is flipped from the front to the back and transported in the direction of the arrow D in the drawing, along the guide within a second transport path (a reversing path) 101.

At this time, the reverse rotation of the reversing roller 9 also causes an intermediate roller 15 to rotate in the direction of the arrow B in STC in FIG. 1 (in reverse), which transports the print medium P in the second transport path 101 toward the feed roller 3.

10 indicates the discharge roller, which transports the print medium P printed onto by the print head 7 in the direction of the reversing roller 9. 12 indicates a spur that rotates while making contact with a printing surface of the print medium P printed onto by the print head 7. Here, the spur 12 is biased toward the discharge roller 10. 13 indicates a reversing driven roller which is biased toward the reversing roller 9 and which transports the print medium P by pinching the print medium P with the reversing roller 9. 14 indicates an intermediate driven roller which is biased toward the intermediate roller 15 and which transports the print medium P by pinching the print medium P with the intermediate roller 15.

The print medium P is guided by the guide within the first transport path 100 between a feed nip part formed by the feed roller 3 and the feed driven roller 4 and a transport nip part formed by the transport roller 5 and the pinch roller 6. 16 indicates a print medium sensor for sensing the leading end and the following end of the print medium P. The print medium sensor 16 is provided downstream from the feed roller 3 in the print medium transport direction.

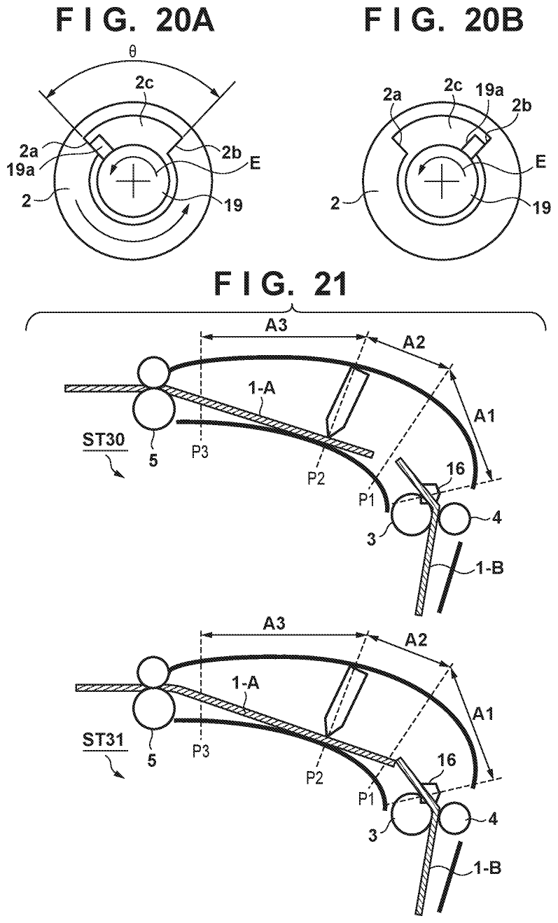

FIGS. 20A and 20B are diagrams illustrating the configuration of the pickup roller 2. As described above, the pickup roller 2 makes contact with the topmost print medium loaded in the paper loading unit 11 to pick up that print medium. 19 indicates a drive shaft for transmitting drive power from a first feed motor 206 to the pickup roller 2. When picking up the print medium P, the drive shaft 19 and the pickup roller 2 rotate in the direction of the arrow E in STA in FIG. 1.

The drive shaft 19 is provided with a projection 19a. A recess 2c into which the projection 19a fits is formed in the pickup roller 2. As illustrated in FIG. 20A, when the projection 19a is in contact with a first surface 2a of the recess 2c in the pickup roller 2, the drive power of the drive shaft 19 is transmitted to the pickup roller 2, and thus the pickup roller 2 rotates when the drive shaft 19 is driven. On the other hand, as illustrated in FIG. 20B, when the projection 19a is in contact with a second surface 2b of the recess 2c in the pickup roller 2, the drive power of the drive shaft 19 is not transmitted to the pickup roller 2, and thus the pickup roller 2 does not rotate even if the drive shaft 19 is driven. Additionally, when the projection 19a is in contact with neither the first surface 2a nor the second surface 2b and is between the first surface 2a and the second surface 2b, the pickup roller 2 also does not rotate even if the drive shaft 19 is driven.

FIG. 19 is a block diagram illustrating the printing apparatus 200 according to the present embodiment. 201 indicates an MPU that controls the operations of various units, data processing, and the like. As will be described later, the MPU 201 functions as a transport control means capable of controlling the transport of print media such that a following end part of a preceding print medium and a leading end part of a following print medium overlap. 202 indicates a ROM that stores programs executed by the MPU 201, data, and the like. 203 indicates a RAM that temporarily stores data processed by the MPU 201, data received from a host computer 214, and the like.

The print head 7 is controlled by a print head driver 212. A carriage motor 204, which drives the carriage 1, is controlled by a carriage motor driver 208. The transport roller 5 and the discharge roller 10 are driven by a transport motor 205. The transport motor 205 is controlled by a transport motor driver 209.

The pickup roller 2, the feed roller 3, and the intermediate roller 15 are driven by the first feed motor 206. The first feed motor 206 is controlled by a first feed motor driver 210. The reversing roller 9 and the intermediate roller 15 are driven by the second feed motor 207.

At this time, the pickup roller 2 and the feed roller 3 rotate synchronously in response to forward driving by the first feed motor 206, and the print medium P is transported in the direction of the transport roller 5. In reverse driving by the first feed motor 206, the following operations are performed as a result of a drive switch (not shown). In reverse driving while in a first drive switch state, only the feed roller 3 rotates, and the print medium P is transported in the direction of the transport roller 5. Then, in reverse driving while in a second drive switch state, the feed roller 3 and the intermediate roller 15 rotate, and the print medium P is transported in the direction of the transport roller 5.

The reversing roller 9 rotates in a direction for discharging the print medium P outside the apparatus as a result of the second feed motor 207 driving forward. Meanwhile, in reverse driving by the second feed motor 207, the reversing roller 9 and the intermediate roller 15 rotate synchronously and transport the print medium P within the second transport path 101 in the direction of the feed roller 3.

The host computer 214 is provided with a printer driver 2141 for compiling print information, such as a print image, the print image quality, and the like, and communicating that print information to the printing apparatus 200, when a user instructs printing operations to be executed. The MPU 201 exchanges print images and the like with the host computer 214 via an I/F unit 213.

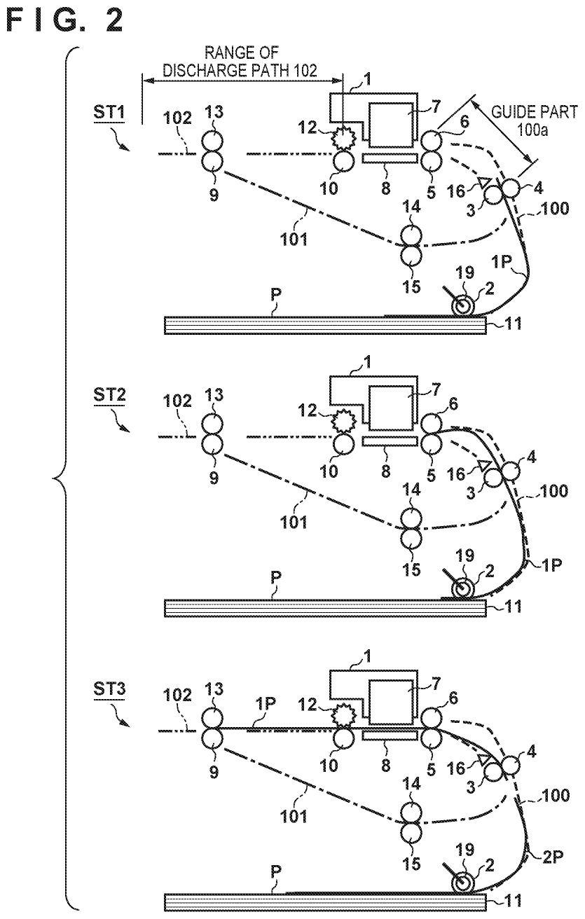

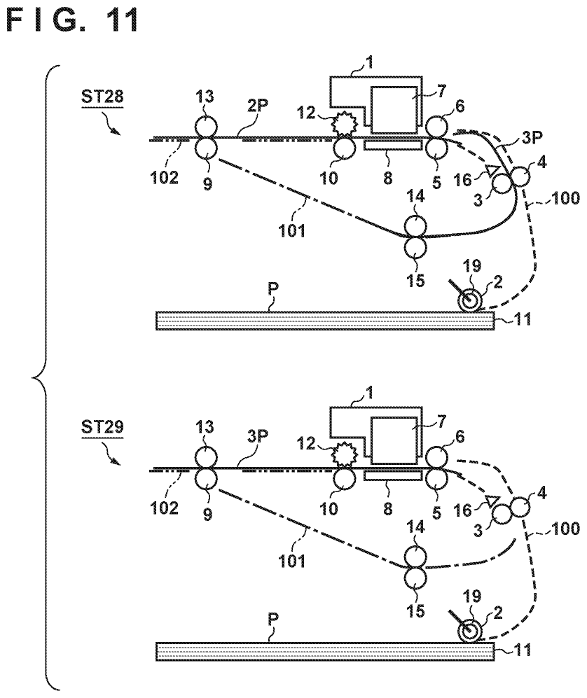

Operations in overlapping continuous feeding during a double-sided printing mode will be described in chronological order, using an example of printing six pages of print data on both sides of three sheets of the print medium P in a single job, with reference to ST1 in FIG. 2 to ST29 in FIG. 11. When the print data in the double-sided printing mode in transmitted from the host computer 214 via the I/F unit 213, the print data is processed by the MPU 201 and then expanded in the RAM 203. The printing operations are then started based on the data expanded by the MPU 201.

Descriptions will be given with reference to ST1 in FIG. 2. First, the first feed motor 206 is driven at a low speed by the first feed motor driver 210 to rotate forward. The pickup roller 2 rotates at 7.6 inches/sec as a result. When the pickup roller 2 rotates, the topmost print medium P loaded in the paper loading unit 11 is picked up. The first print medium P picked up by the pickup roller 2 is transported by the feed roller 3, which is rotating in the same direction as the pickup roller 2, while being guided by the guide part 100a. The feed roller 3 is also driven by the first feed motor 206. The present embodiment describes a configuration that includes the pickup roller 2 and the feed roller 3. However, the configuration may be such that only the feed roller 3 that feeds the print medium loaded in the paper loading unit 11 is included.

When the leading end of the first print medium P is sensed by the print medium sensor 16 provided downstream from the feed roller 3 in the transport direction, the first feed motor 206 is switched to high-speed driving while continuing to drive forward. In other words, the pickup roller 2 and the feed roller 3 rotate at 20 inches/sec.

Descriptions will now be given with reference to ST2 in FIG. 2. As the feed roller 3 continues to rotate, the downstream-side leading end of the first print medium P in the transport direction contacts the transport nip part formed by the transport roller 5 and the pinch roller 6. The transport roller 5 is stopped at this time. The feed roller 3 is rotated a predetermined amount even after the downstream-side leading end of the first print medium P in the transport direction contacts the transport nip part, and as a result, the leading end of the first print medium P is aligned while in contact with the transport nip part, which corrects skew. These skew correction operations are also called “registration operations”.

Descriptions will now be given with reference to ST3 in FIG. 2. Once the skew correction operations for the first print medium P end, the transport roller 5 begins rotating as a result of being driven by the transport motor 205. The transport roller 5 transports the print medium at 15 inches/sec. After the first print medium P is cued to a position opposite the print head 7, the print head 7 ejects ink based on a first page of print data, which starts printing operations on the first surface of the first print medium P.

Here, the length of the print medium P in the transport direction is indicated by L, as illustrated in FIG. 25. When printing onto the first surface of the print medium P, which is printed first, the print density of an S region (a (¼) L part) at the leading end part in the transport direction, at the current stage indicated by the arrow A, is compared with a pre-set print density. S(1)=0 is stored in the RAM 203 if, as a result of the comparison, the print density in the S region is within the pre-set print density, whereas S(1)=1 is stored if not. The number in the parentheses indicates the number of sheets printed.

Additionally, when the printing operations on the first print medium P progress, the print density of a K region (a (¼) L part) at the following end part in the transport direction, at the current stage indicated by the arrow A, is compared with a pre-set print density. K(1)=0 is stored in the RAM 203 if, as a result of the comparison, the print density in the K region is within the pre-set print density, whereas K(1)=1 is stored if not. The number in the parentheses indicates the number of sheets printed here as well.

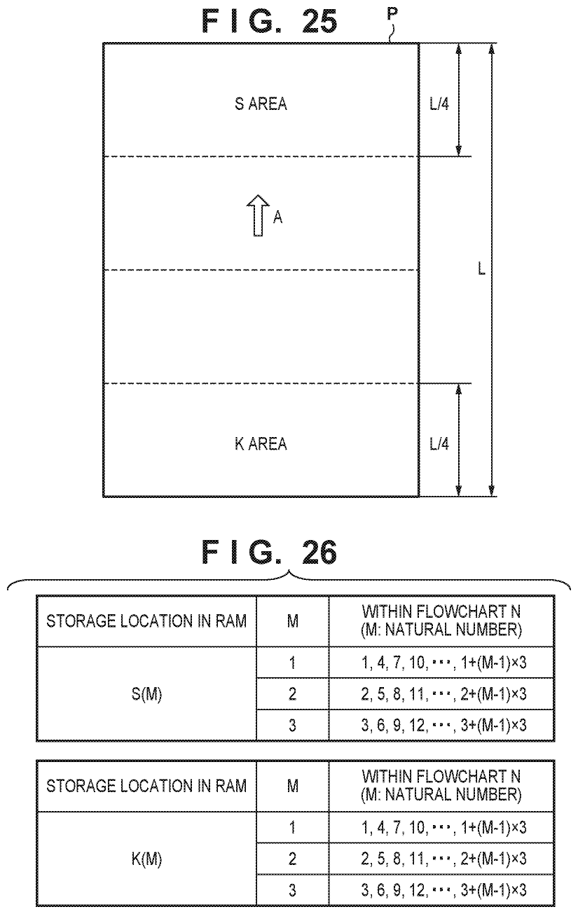

Additionally, as illustrated in FIG. 26, when a number of printed sheets N of the print medium P becomes at least four, the value of N in S(N) and K(N) is converted to the value of M in the table, and is overwritten in the storage regions of S(M) and K(M) as needed.

Note that the cueing operations are performed by first positioning the leading end of the first print medium P at the position of the transport roller 5 by bringing the leading end into contact with the transport nip part, and then controlling the rotation amount of the transport roller 5 using the position of the transport roller 5 as a reference. When it is necessary to pick up the second print medium P from the paper loading unit 11 using the pickup roller 2 during the cueing operations, the first feed motor 206 is driven forward, and the pickup roller 2 and the feed roller 3 are also driven in synchronization with the transport roller 5.

When it is not necessary to pick up the second print medium P, the first feed motor 206 is driven in reverse in the first drive switch state, and only the feed roller 3 is driven in synchronization with the transport roller 5.

When there is print data to be printed on the second and subsequent print media P, in the present embodiment, the print medium P on which printing operations are to be performed after the printing operations on the first surface of the first print medium P is the second print medium P picked up from the paper loading unit 11. The first surface thereof is then set to be printed onto after the first surface of the first print medium P. Accordingly, it is necessary to pick up the second print medium P after the upstream-side end part (the following end part) of the first print medium P in the transport direction passes the pickup roller 2 and the drive shaft 19 is driven for a predetermined length of time (delayed feeding). The first feed motor 206 is therefore driven forward.

The printing apparatus in the present embodiment is a serial-type printing apparatus in which the print head 7 is mounted on the carriage 1. Transport operations, in which the print medium is transported by the transport roller 5 intermittently by a predetermined amount at a time, and image forming operations, in which ink is ejected from the print head 7 while moving the carriage 1 on which the print head 7 is mounted while the transport roller 5 is stopped, are repeated. As a result of these operations, the printing operations are performed on the first print medium P.

Once the first print medium P is cued, the forward driving of the first feed motor 206 is switched to low-speed driving. In other words, the pickup roller 2 and the feed roller 3 rotate at 7.6 inches/sec. When the first print medium P is transported by the transport roller 5 intermittently by a predetermined amount at a time, the feed roller 3 is also driven intermittently by the first feed motor 206. In other words, when the transport roller 5 is rotating, the feed roller 3 also rotates, and when the transport roller 5 is stopped, the feed roller 3 is also stopped. The rotational speed of the feed roller 3 is lower than the rotational speed of the transport roller 5 (the transport speed). Accordingly, the print medium P becomes taut between the transport roller 5 and the feed roller 3. In other words, the feed roller 3 is rotated by the first print medium P transported by the transport roller 5.

The first feed motor 206 is driven forward intermittently, and the drive shaft 19 is therefore also driven. As described earlier, the rotational speed of the pickup roller 2 is lower than the rotational speed of the transport roller 5. As such, the pickup roller 2 is rotated by the print medium P transported by the transport roller 5. In other words, the pickup roller 2 is moving ahead of the drive shaft 19. Specifically, the projection 19a of the drive shaft 19 has separated from the first surface 2a and is in contact with the second surface 2b. Accordingly, even if the upstream-side end part (following end part) of the first print medium P, in the transport direction, passes the pickup roller 2, the second print medium P will not be immediately picked up. When the drive shaft 19 is driven for a predetermined length of time, the projection 19a contacts the first surface 2a and the pickup roller 2 begins rotating.

Due to factors such as sensor responsiveness and the like, the print medium sensor 16 requires at least a predetermined interval between print media in order to sense the end part of the print medium P. In other words, it is necessary to provide a predetermined time interval between when the print medium sensor 16 senses the upstream-side end part (the following end part) of the first print medium P in the transport direction and when the print medium sensor 16 senses the downstream-side leading end part of the second print medium P in the transport direction. As such, it is necessary for the upstream-side end part of the first print medium P in the transport direction and the downstream-side leading end part of the second print medium P in the transport direction to be separated by a predetermined distance, and the recess 2c of the pickup roller 2 is set to approximately 70 degrees.

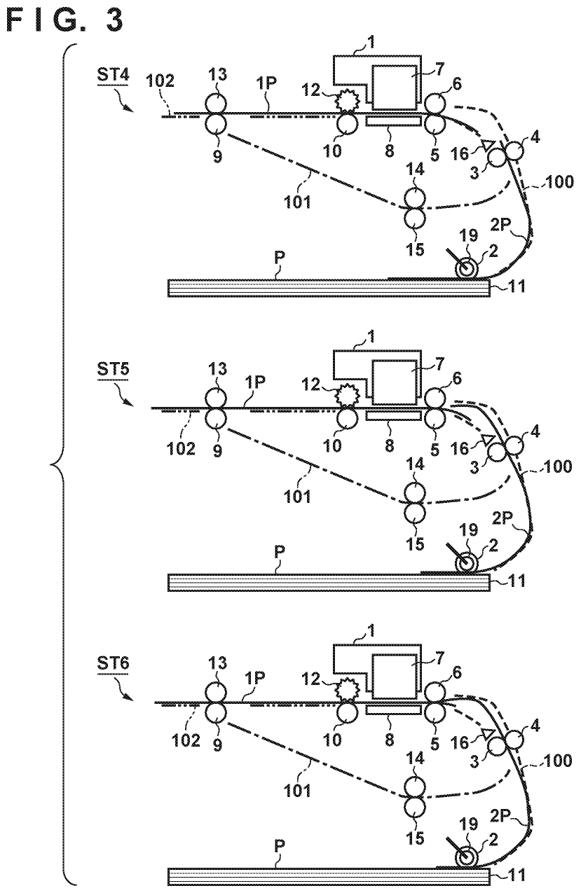

Descriptions will now be given with reference to ST4 in FIG. 3. The second print medium P picked up by the pickup roller 2 is transported by the feed roller 3. At this time, image forming operations are being performed on the first print medium P by the print head 7 based on the print data. When the leading end of the second print medium P is sensed by the print medium sensor 16, the first feed motor 206 is switched to high-speed driving while continuing to drive forward. In other words, the pickup roller 2 and the feed roller 3 rotate at 20 inches/sec.

Descriptions will now be given with reference to ST5 in FIG. 3.

Moving the second print medium P at a higher speed than the speed at which the first print medium P is moved downstream as a result of the printing operations by the print head 7 makes it possible to create a state where the downstream-side leading end part of the second print medium P in the transport direction overlaps the upstream-side end part of the first print medium P in the transport direction.

The printing operations are performed based on the print data for the first print medium P, and thus the first print medium P is transported intermittently by the transport roller 5. On the other hand, continuously rotating the feed roller 3 at 20 inches/sec after the downstream-side leading end of the second print medium P in the transport direction is sensed by the print medium sensor 16 makes it possible for the second print medium P to catch up to the first print medium P. The second print medium P is then transported by the feed roller 3 until the downstream-side leading end thereof in the transport direction stops at a predetermined position upstream from the transport nip. The position of the downstream-side leading end of the second print medium P in the transport direction is calculated from the rotation amount of the feed roller 3 after the downstream-side leading end of the second print medium P in the transport direction is sensed by the print medium sensor 16, and is controlled based on the result of the calculation. At this time, image forming operations are being performed on the first print medium P by the print head 7 based on the print data.

Descriptions will now be given with reference to ST6 in FIG. 3. When the transport roller 5 is stopped to perform the image forming operations (ink ejection operations) for the final line of the first print medium P, the skew correction operations for the second print medium P are performed by driving the feed roller 3 to cause the leading end of the second print medium P to contact the transport nip part.

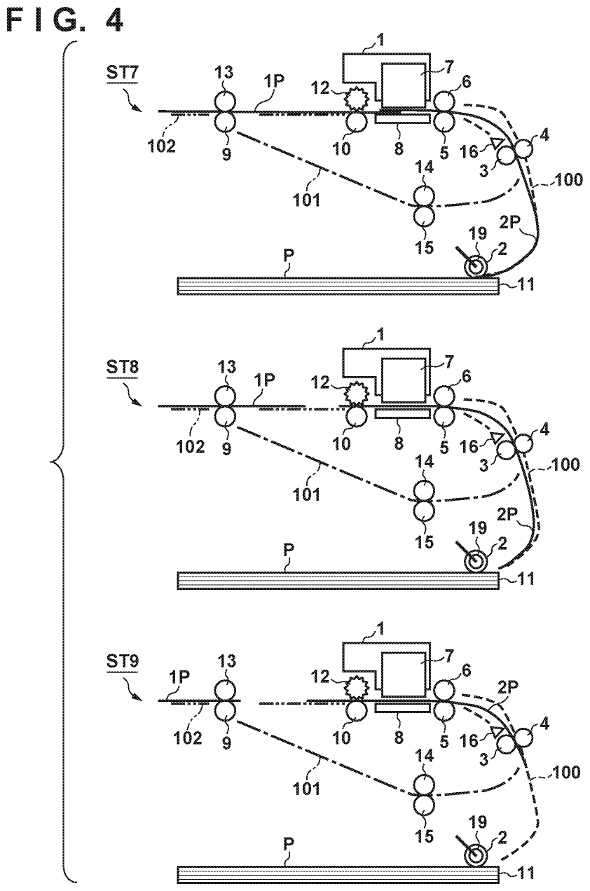

Descriptions will now be given with reference to ST7 in FIG. 4. When the image forming operations for the final line of the first print medium P end, the second print medium P can be cued by rotating the transport roller 5 by a predetermined amount and keeping the second print medium P in a state of overlap on the first print medium P.

After the second print medium P is fed by the pickup roller 2 from the paper loading unit 11, it is determined whether the print medium P to be cued has been fed from the paper loading unit 11. When it is determined that the print medium P to be cued has been fed from the paper loading unit 11, the next print medium P after that print medium P is selected to be fed from the second transport path 101 to a position opposite the print head 7. In this determination, the second print medium P is determined to have been fed from the paper loading unit 11, and thus the next print medium P after the second print medium P to be cued is fed from the second transport path 101 to the position opposite the print head 7. It is also necessary that the next print medium P after the second print medium P to be cued is not fed from the paper loading unit 11 at a delay. Furthermore, because the second print medium P is being fed from the paper loading unit 11, the cueing of the second print medium P is performed by driving the first feed motor 206 in reverse, in the first drive switch state. Control is performed to drive the feed roller 3 along with the transport roller 5, without transmitting drive force to the pickup roller 2 and the intermediate roller 15.

Once the second print medium P is cued, the first feed motor 206 is switched to low-speed driving, while continuing to drive in reverse in the first drive switch state. In other words, the feed roller 3 rotates at 7.6 inches/sec. When the second print medium P is transported by the transport roller 5 intermittently by a predetermined amount at a time, the feed roller 3 is also driven intermittently by the first feed motor 206. Printing operations are performed on the second print medium P by the print head 7 based on the print data.

At this time, similar to the above-described printing onto the first surface of the first print medium P, the print densities are compared, with S(2)=0 being stored in the RAM 203 if the print density of the S region falls within a pre-set print density, and S(2)=1 being stored if not. Additionally, when the printing operations on the second print medium P progress, the print density of a K region (a (¼) L part) at the following end part of the second print medium in the transport direction, at the current stage, is compared with a pre-set print density (see FIG. 25). K(2)=0 is stored in the RAM 203 if, as a result of the comparison, the print density in the K region is within the pre-set print density, whereas K(2)=1 is stored if not. When the second print medium P is transported intermittently for the printing operations, the first print medium P is also transported intermittently.

Descriptions will now be given with reference to ST8 in FIG. 4. After determining that the upstream-side end part of the first print medium P in the transport direction has passed the spur 12 based on the rotation amount of the transport roller 5 since the start of the cueing operations and the length of the sheets, the second feed motor 207 is rotated forward at high speed by a second feed motor driver 211. The reversing roller 9 is rotated at 18 inches/sec in the direction of the arrow A in FIG. 1. As a result, the speed at which the first print medium P is transported by the reversing roller 9 becomes faster than the speed at which the second print medium P is transported by the transport roller 5. The upstream-side end part of the first print medium P in the transport direction and the downstream-side leading end of the second print medium P in the transport direction no longer overlap. Then, as will be described later, after the first print medium P is reversed by the reversing roller 9, enters into the second transport path 101, and the upstream-side following end thereof in the transport direction passes the reversing roller 9, the downstream-side leading end of the second print medium P in the transport direction can pass the reversing roller 9. The “upstream-side following end of the first print medium P within the second transport path 101” means the downstream-side leading end in the first transport path 100 before the reversal.

Descriptions will now be given with reference to ST) in FIG. 4. When the reversing roller 9 rotates in the direction of the arrow A in STA in FIG. 1, the first print medium P is transported in the direction of the arrow C in STA in FIG. 1. As a result, the first print medium P is continuously transported until the upstream-side end part thereof in the transport direction reaches a predetermined position on the upstream side of the reversing roller 9 in the transport direction. Accordingly, the upstream-side end part of the first print medium P in the transport direction, and the downstream-side leading end of the second print medium P in the transport direction, which is being transported intermittently by a predetermined amount, are pulled apart.

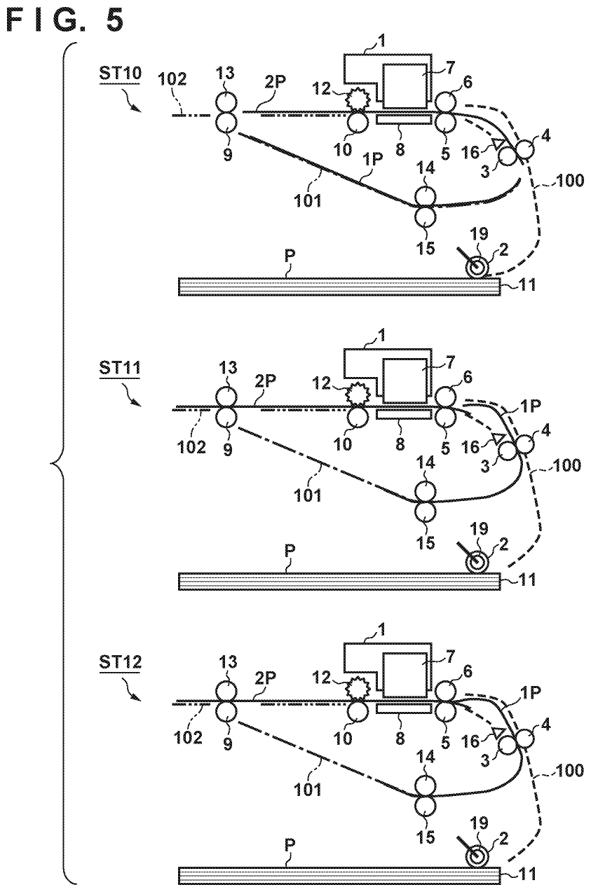

Descriptions will now be given with reference to ST10 in FIG. 5. When the upstream-side end part of the first print medium P in the transport direction reaches the predetermined position on the upstream side of the reversing roller 9 in the transport direction, the second feed motor 207 is driven in reverse at high speed by the second feed motor driver 211. As a result, the reversing roller 9 and the intermediate roller 15 are rotated at 18 inches/sec in the direction of the arrow B in STC in FIG. 1. Then, the first print medium P is transported by the reversing roller 9 and the intermediate roller 15 along the guide within the second transport path (the reversing path) 101, until the downstream-side leading end thereof in the transport direction reaches a predetermined position before the first transport path 100. The predetermined position at this time is also calculated based on the rotation amount of the transport roller 5 since the start of the cueing operations and the length of the sheets.

Descriptions will now be given with reference to ST11 in FIG. 5. When the transport of the second print medium P progresses and the upstream-side end part of the second print medium P in the transport direction is sensed by the print medium sensor 16, the first feed motor 206 is driven in reverse at low speed in the second drive switch state by the first feed motor driver 210. As a result, the intermediate roller 15 and the feed roller 3 are rotated at 7.6 inches/sec in the direction of the arrow B in STC in FIG. 1. Then, the first print medium P is transported by the intermediate roller 15 and the feed roller 3 from the second transport path 101 to the first transport path 100 in the direction of the transport roller 5. At this time, image forming operations are being performed on the second print medium P by the print head 7 based on the print data. When the downstream-side leading end of the first print medium P in the transport direction is sensed by the print medium sensor 16, the first feed motor 206 is switched to high-speed driving while continuing to drive in reverse in the second drive switch state. In other words, the intermediate roller 15 and the feed roller 3 rotate at 20 inches/sec.

Before the first feed motor 206 is switched to high-speed driving, the above-described values of the downstream-side end part of the first print medium P in the transport direction and the upstream-side end part of the second print medium P in the transport direction, stored in the RAM 203, are checked. The “downstream-side end part of the first print medium P within the second transport path 101” means the upstream-side end part in the first transport path 100 before the reversal. In other words, the value of K(1) stored in the RAM 203 at the time of printing onto the following end part of the first surface of the first print medium P and the value of K(2) in the K region of the second print medium P are checked. If both K(1) and K(2) are 0, the first feed motor 206 is switched to high-speed driving. If either K(1) or K(2) is 1, the preceding print medium and the following print medium may not be able to overlap due to the print medium P curling, and thus the first feed motor 206 is not switched to high-speed driving.

At the current stage, the value of K(2) in the K region of the second print medium P is initially 0 because the image data has not yet been printed. Accordingly, when the value of K(1) is 1, the first feed motor 206 is not switched to high-speed driving, and the downstream-side leading end of the first print medium P in the transport direction is not caused to overlap with the upstream-side end part of the second print medium P in the transport direction. The descriptions will continue with a case where the value of K(1) is 0 and the first feed motor 206 is switched to high-speed driving.

Moving the first print medium P at a higher speed than the speed at which the second print medium P is moved downstream as a result of the printing operations by the print head 7 makes it possible to create a state where the leading end part of the first print medium P overlaps the following end part of the second print medium P. The printing operations are performed based on the print data for the second print medium P, and thus the second print medium P is transported intermittently by the transport roller 5. On the other hand, continuously rotating the feed roller 3 and the intermediate roller 15 at 20 inches/sec after the leading end of the first print medium P is sensed by the print medium sensor 16 makes it possible for the first print medium P to catch up to the second print medium P.

The first print medium P is then transported by the feed roller 3 until the downstream-side leading end thereof in the transport direction stops at a predetermined position upstream from the transport nip. The position of the downstream-side leading end of the first print medium P in the transport direction is calculated from the rotation amount of the feed roller 3 after the downstream-side leading end of the first print medium P in the transport direction is sensed by the print medium sensor 16, and is controlled based on the result of the calculation. At this time, image forming operations are being performed on the second print medium P by the print head 7 based on the print data.

Descriptions will now be given with reference to ST12 in FIG. 5. When the transport roller 5 is stopped to perform the image forming operations (ink ejection operations) for the final line of the second print medium P, the skew correction operations for the first print medium P are performed by driving the feed roller 3 to cause the downstream-side leading end of the first print medium P in the transport direction to contact the transport nip part.

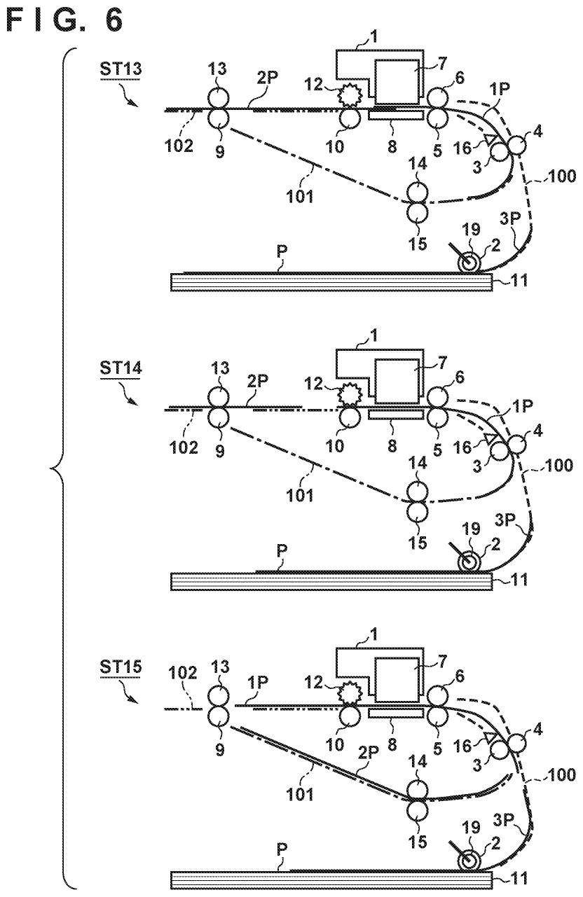

Descriptions will now be given with reference to ST13 in FIG. 6. When the image forming operations for the final line of the second print medium P end, the first print medium P can be cued by rotating the transport roller 5 by a predetermined amount and keeping the first print medium P in a state of overlap on the second print medium P.

As described earlier, after the second print medium P is fed by the pickup roller 2 from the paper loading unit 11, it is determined whether the print medium P to be cued has been fed from the paper loading unit 11. When it is determined that the print medium P has been fed from the second transport path 101, it is further determined whether the print data for the second surface of the print medium P on which the printing operations are being performed immediately before the cueing is the final print data in the one job. The following control is performed when it is determined that the print medium P to be cued has been fed from the second transport path 101 and the print data for the second surface of the print medium P on which the printing operations are being performed immediately before is the final print data in the one job. That is, the next print medium P after the print medium P to be cued is selected to be fed from the second transport path to the position opposite the print head 7.

Additionally, the following control is performed when it is determined that the print medium P to be cued has been fed from the second transport path 101 and the print data for the second surface of the print medium P on which the printing operations are being performed immediately before is not the final print data in the one job. That is, the next print medium P after the print medium P to be cued is selected to be fed from the paper loading unit 11 to the position opposite the print head 7.

In this determination, it is determined that the first print medium P is fed from the second transport path 101 and the print data for the second surface of the second print medium P is not the final print data in the one job. As such, the next print medium P after the first print medium P to be cued is fed from the paper loading unit 11 to the position opposite the print head 7. It is also necessary that the next print medium P after the first print medium P to be cued is not fed from the paper loading unit 11 at a delay. Furthermore, the first print medium P is being fed from the second transport path 101. Accordingly, the cueing of the first print medium P is performed by driving the first feed motor 206 in reverse in the second drive switch state, and driving the feed roller 3 and the intermediate roller 15 along with the transport roller 5 without driving the pickup roller 2.

The intermediate roller 15 and the intermediate driven roller 14 are disposed in a positional relationship such that the upstream-side end part of the first print medium P in the transport direction passes the nip at the intermediate roller 15 as a result of cueing the first print medium P.

Next, the first feed motor 206 starts driving forward at low speed in the first drive switch state. In other words, the pickup roller 2 and the feed roller 3 rotate at 7.6 inches/sec. When the first print medium P is transported by the transport roller 5 intermittently by a predetermined amount at a time, the pickup roller 2 and the feed roller 3 are also driven intermittently by the first feed motor 206. Printing operations are performed on the first print medium P by the print head 7 based on the print data. When the first print medium P is transported intermittently for printing operations, a third print medium P picked up from the paper loading unit 11 by the pickup roller 2 is also transported intermittently.

Descriptions will now be given with reference to ST14 in FIG. 6. After determining that the upstream-side end part of the second print medium P in the transport direction has passed the spur 12 based on the rotation amount of the transport roller 5 since the start of the cueing operations and the length of the sheets, the second feed motor 207 is rotated forward at high speed by a second feed motor driver 211. The reversing roller 9 is rotated at 18 inches/sec in the direction of the arrow A in FIG. 1. As a result, the speed at which the second print medium P is transported by the reversing roller 9 becomes faster than the speed at which the first print medium P is transported by the transport roller 5. The upstream-side end part of the second print medium P in the transport direction and the downstream-side leading end of the first print medium P in the transport direction no longer overlap. Then, after the second print medium P is reversed by the reversing roller 9, enters into the second transport path 101, and the upstream-side following end thereof in the transport direction passes the reversing roller 9, the downstream-side leading end of the first print medium P in the transport direction can pass the reversing roller 9. The “upstream-side following end of the second print medium P within the second transport path 101” means the downstream-side leading end in the first transport path 100 before the reversal.

Descriptions will now be given with reference to ST15 in FIG. 6. When the reversing roller 9 rotates in the direction of the arrow A in STA in FIG. 1, the second print medium P is transported in the direction of the arrow C in STA in FIG. 1. As a result, the second print medium P is continuously transported until the upstream-side end part thereof in the transport direction reaches a predetermined position on the upstream side of the reversing roller 9 in the transport direction. Accordingly, the upstream-side end part of the second print medium P in the transport direction, and the downstream-side leading end of the first print medium P in the transport direction, which is being transported intermittently by a predetermined amount, are pulled apart.

When the upstream-side end part of the second print medium P in the transport direction reaches the predetermined position on the upstream side of the reversing roller 9 in the transport direction, the second feed motor 207 is driven in reverse at high speed by the second feed motor driver 211. As a result, the reversing roller 9 and the intermediate roller 15 are rotated at 18 inches/sec in the direction of the arrow B in STC in FIG. 1. Then, the second print medium P is transported by the reversing roller 9 and the intermediate roller 15 along the guide within the second transport path (the reversing path) 101, until the downstream-side leading end thereof in the transport direction reaches a predetermined position before the first transport path 100. The predetermined position at this time is also calculated based on the rotation amount of the transport roller 5 since the start of the cueing operations and the length of the sheets.

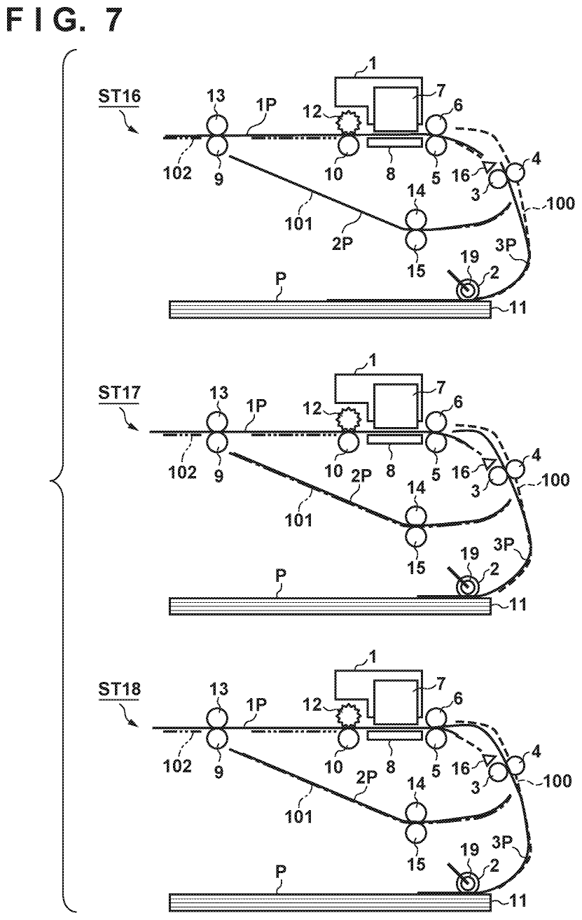

Descriptions will now be given with reference to ST16 in FIG. 7. The third print medium P picked up from the paper loading unit 11 by the pickup roller 2 is transported by the feed roller 3. At this time, image forming operations are being performed on the first print medium P by the print head 7 based on the print data. When the leading end of the third print medium P is sensed by the print medium sensor 16, the first feed motor 206 is switched to high-speed driving while continuing to drive forward. In other words, the pickup roller 2 and the feed roller 3 rotate at 20 inches/sec.

Similar to the operations described earlier, at this time too, before the first feed motor 206 is switched to high-speed driving, the above-described values of the upstream-side end part of the preceding print medium P in the transport direction and the downstream-side leading end part of the following print medium P in the transport direction, stored in the RAM 203, are checked. In other words, the value of S(1) stored in the RAM 203 at the time of printing onto the leading end part of the first surface of the first print medium P and the value of S(3) in the S region of the third print medium P are checked. Note that the S region of the leading end part in the printing onto the first surface of the first print medium P becomes the upstream-side end part of the first print medium P in the transport direction (the following end part) when reversed and fed to the printing position through the second transport path 101. If both S(1) and S(3) are 0, the first feed motor 206 is switched to high-speed driving. If either S(1) or S(3) is 1, the preceding print medium and the following print medium may not be able to overlap due to the print medium P curling, and thus the first feed motor 206 is not switched to high-speed driving. At the current stage, the value of S(3) in the S region of the third print medium P is initially 0 because the image data has not yet been printed. When the value of S(1) is 1, the first feed motor 206 is not switched to high-speed driving, and the downstream-side leading end of the third print medium P in the transport direction is not caused to overlap with the upstream-side end part of the first print medium P in the transport direction. The descriptions will continue with a case where the value of S(1) is 0 and the first feed motor 206 is switched to high-speed driving.

Descriptions will now be given with reference to ST17 in FIG. 7. Moving the third print medium P at a higher speed than the speed at which the first print medium P is moved downstream as a result of the printing operations by the print head 7 makes it possible to create a state where the leading end part of the third print medium P overlaps the following end part of the first print medium P. The printing operations are performed based on the print data for the first print medium P, and thus the first print medium P is transported intermittently by the transport roller 5. On the other hand, continuously rotating the feed roller 3 at 20 inches/sec after the leading end of the third print medium P is sensed by the print medium sensor 16 makes it possible for the third print medium P to catch up to the first print medium P. The third print medium P is then transported by the feed roller 3 until the downstream-side leading end thereof in the transport direction stops at a predetermined position upstream from the transport nip. The position of the downstream-side leading end of the third print medium P in the transport direction is calculated from the rotation amount of the feed roller 3 after the downstream-side leading end of the third print medium P in the transport direction is sensed by the print medium sensor 16, and is controlled based on the result of the calculation. At this time, image forming operations are being performed on the first print medium P by the print head 7 based on the print data.

Descriptions will now be given with reference to ST18 in FIG. 7. When the transport roller 5 is stopped to perform the image forming operations (ink ejection operations) for the final line of the first print medium P, the skew correction operations for the third print medium P are performed by driving the feed roller 3 to cause the leading end of the third print medium P to contact the transport nip part.

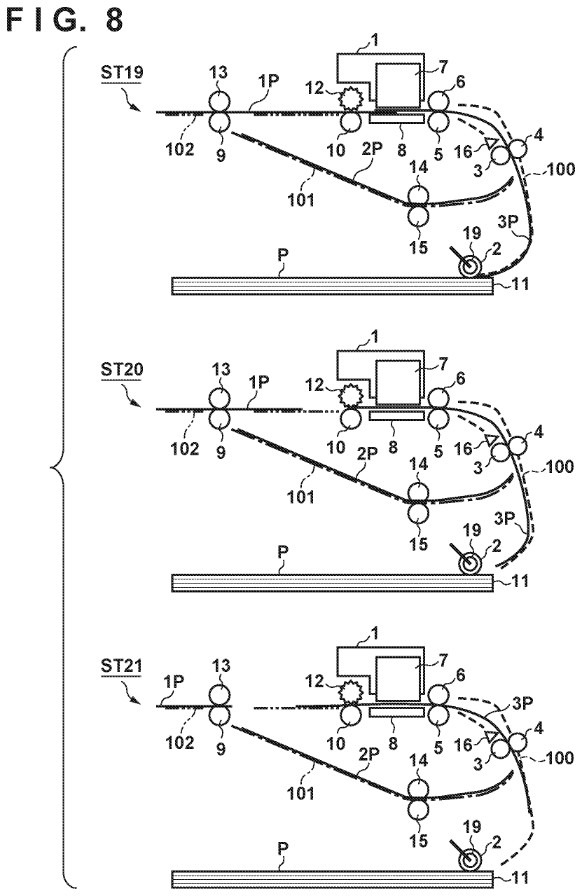

Descriptions will now be given with reference to ST19 in FIG. 8. When the image forming operations for the final line of the first print medium P end, the third print medium P can be cued by rotating the transport roller 5 by a predetermined amount and keeping the third print medium P in a state of overlap on the first print medium P.

As described earlier, after the second print medium P is fed by the pickup roller 2 from the paper loading unit 11, it is determined whether the print medium P to be cued has been fed from the paper loading unit 11. When it is determined that the print medium P has been fed from the paper loading unit 11, the next print medium P after that print medium P to be cued is selected to be fed from the second transport path 101 to a position opposite the print head 7. In this determination, the third print medium P is determined to have been fed from the paper loading unit 11, and thus the next print medium P after the third print medium P to be cued is fed from the second transport path 101 to the position opposite the print head 7. It is also necessary that the next print medium P after the third print medium P to be cued is not fed from the paper loading unit 11 at a delay. Furthermore, the third print medium P is being fed from the paper loading unit 11. Accordingly, in the cueing of the third print medium P, control is performed such that the first feed motor 206 is driven in reverse in the first drive switch state, and the feed roller 3 is driven along with the transport roller 5 without transmitting drive force to the pickup roller 2 and the intermediate roller 15.

Once the third print medium P is cued, the first feed motor 206 is switched to low-speed driving, while continuing to drive in reverse in the first drive switch state. In other words, the feed roller 3 rotates at 7.6 inches/sec. When the third print medium P is transported by the transport roller 5 intermittently by a predetermined amount at a time, the feed roller 3 is also driven intermittently by the first feed motor 206. Printing operations are performed on the third print medium P by the print head 7 based on the print data. At this time, similar to the above-described printing onto the first surface of the second print medium P, the print densities are compared, with S(3)=0 being stored in the RAM 203 if the print density of the S region falls within a pre-set print density, and S(3)=1 being stored if not. Additionally, when the printing operations on the third print medium P progress, the print density of a K region (a (¼) L part) at the following end part of the third print medium in the transport direction, at the current stage, is compared with a pre-set print density. K(3)=0 is stored in the RAM 203 if, as a result of the comparison, the print density in the K region is within the pre-set print density, whereas K(3)=1 is stored if not. When the third print medium P is transported intermittently for the printing operations, the first print medium P is also transported intermittently.

Descriptions will now be given with reference to ST20 in FIG. 8. After determining that the upstream-side end part of the first print medium P in the transport direction has passed the spur 12 based on the rotation amount of the transport roller 5 since the start of the cueing operations and the length of the sheets, the second feed motor 207 is rotated forward at high speed by a second feed motor driver 211. The reversing roller 9 is rotated at 18 inches/sec in the direction of the arrow A in FIG. 1. As a result, the speed at which the first print medium P is transported by the reversing roller 9 becomes faster than the speed at which the third print medium P is transported by the transport roller 5. The upstream-side end part of the first print medium P in the transport direction and the downstream-side leading end of the third print medium P in the transport direction no longer overlap.

Descriptions will now be given with reference to ST21 in FIG. 8. When the reversing roller 9 rotates in the direction of the arrow A in STA in FIG. 1, the first print medium P is transported in the direction of the arrow C in STA in FIG. 1. The printing onto the first surface and the second surface of the first print medium P is complete. As such, the first print medium P is discharged to the exterior of the apparatus by the reversing roller 9 rotating at 18 inches/sec in the direction of the arrow A in STA in FIG. 1. Additionally, the upstream-side end part of the first print medium P in the transport direction, and the downstream-side leading end of the third print medium P in the transport direction, which is being transported intermittently by a predetermined amount, are pulled apart.

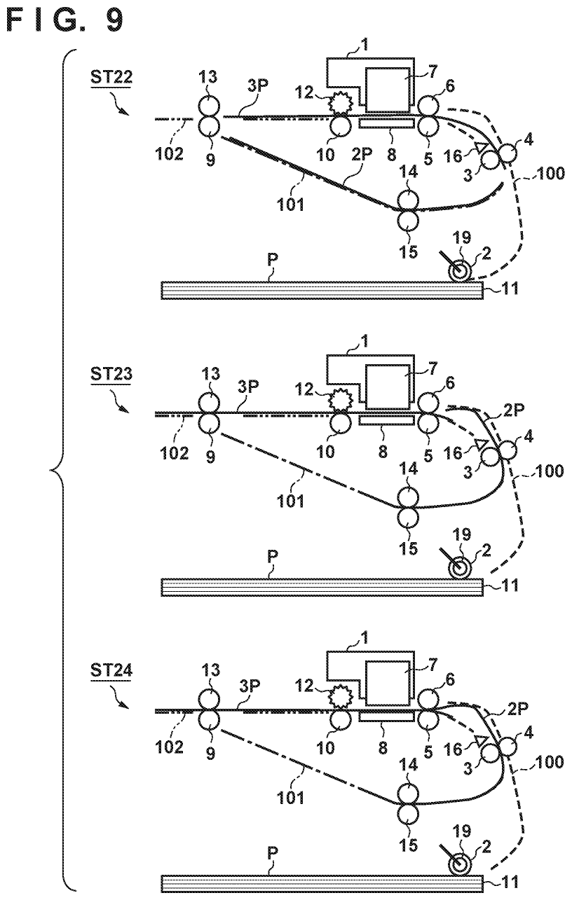

Descriptions will now be given with reference to ST22 and ST23 in FIG. 9. As the transport of the third print medium P progresses, the upstream-side end part of the third print medium P in the transport direction reaches a position corresponding to the timing at which the second print medium P starts being fed from the second transport path 101 by the intermediate roller 15. The first feed motor 206 is then driven in reverse at low speed by the first feed motor driver 210 in the second drive switch state. As a result, the intermediate roller 15 and the feed roller 3 are rotated at 7.6 inches/sec in the direction of the arrow B in STC in FIG. 1. Then, the second print medium P is transported by the intermediate roller 15 and the feed roller 3 from the second transport path 101 to the first transport path 100 in the direction of the transport roller 5. At this time, image forming operations are being performed on the third print medium P by the print head 7 based on the print data. When the downstream-side leading end of the second print medium P in the transport direction is sensed by the print medium sensor 16, the first feed motor 206 is switched to high-speed driving while continuing to drive in reverse in the second drive switch state. In other words, the intermediate roller 15 and the feed roller 3 rotate at 20 inches/sec.

Similar to the operations described earlier, at this time too, before the first feed motor 206 is switched to high-speed driving, the above-described values of the upstream-side end part of the preceding print medium P in the transport direction and the downstream-side leading end part of the following print medium P in the transport direction, stored in the RAM 203, are checked. In other words, the value of K(3) of the K region of the upstream-side end part of the third print medium P, and the value of K(2) of the downstream-side leading end part stored in the RAM 203 when printing onto the following end part of the first surface of the second print medium P, are checked. The “downstream-side leading end part of the second print medium P within the second transport path 101” means the upstream-side following end part in the first transport path 100 before the reversal. If both K(3) and K(2) are 0, the first feed motor 206 is switched to high-speed driving. If either K(3) or K(2) is 1, the preceding print medium and the following print medium may not be able to overlap due to the print medium P curling, and thus the first feed motor 206 is not switched to high-speed driving. At the current stage, the value of K(3) in the K region of the third print medium P is initially 0 because the image data has not yet been printed. Accordingly, when the value of K(2) is 1, the first feed motor 206 is not switched to high-speed driving, and the downstream-side leading end of the second print medium P in the transport direction is not caused to overlap with the upstream-side end part of the third print medium P in the transport direction. The descriptions will continue with a case where the value of K(2) is 0 and the first feed motor 206 is switched to high-speed driving.

Moving the second print medium P at a higher speed than the speed at which the third print medium P is moved downstream as a result of the printing operations by the print head 7 makes it possible to create a state where the leading end part of the second print medium P overlaps the following end part of the third print medium P. The printing operations are performed based on the print data for the third print medium P, and thus the third print medium P is transported intermittently by the transport roller 5. On the other hand, continuously rotating the feed roller 3 and the intermediate roller 15 at 20 inches/sec after the leading end of the second print medium P is sensed by the print medium sensor 16 makes it possible for the second print medium P to catch up to the third print medium P. The second print medium P is then transported by the feed roller 3 until the downstream-side leading end thereof in the transport direction stops at a predetermined position upstream from the transport nip. The position of the leading end of the second print medium P is calculated from the rotation amount of the feed roller 3 after the leading end of the second print medium P is sensed by the print medium sensor 16, and is controlled based on the result of the calculation. At this time, image forming operations are being performed on the third print medium P by the print head 7 based on the print data.

Descriptions will now be given with reference to ST24 in FIG. 9. When the transport roller 5 is stopped to perform the image forming operations (ink ejection operations) for the final line of the third print medium P, the skew correction operations for the second print medium P are performed by driving the feed roller 3 to cause the downstream-side leading end of the second print medium P in the transport direction to contact the transport nip part.

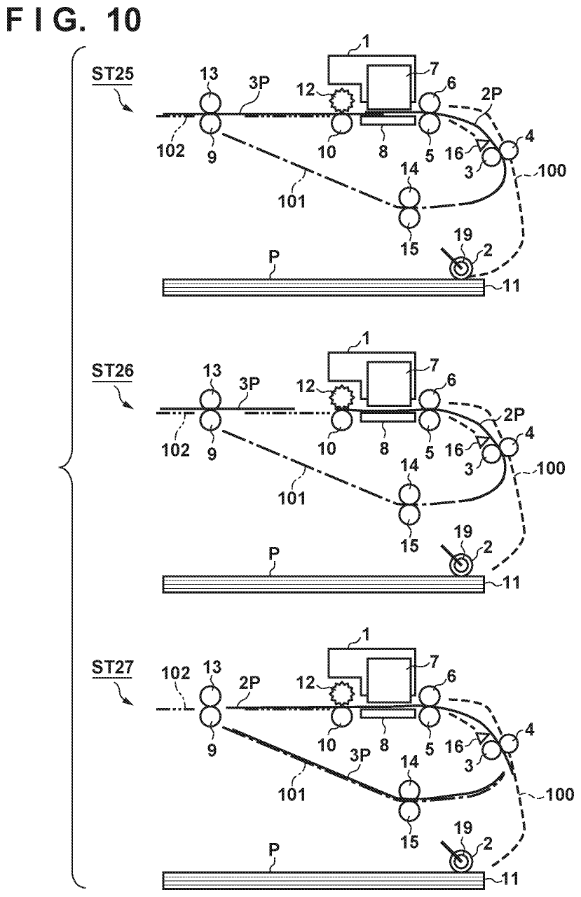

Descriptions will now be given with reference to ST25 in FIG. 10. When the image forming operations for the final line of the third print medium P end, the second print medium P can be cued by rotating the transport roller 5 by a predetermined amount and keeping the second print medium P in a state of overlap on the third print medium P.

As described earlier, after the second print medium P is fed by the pickup roller 2 from the paper loading unit 11, it is determined whether the print medium P to be cued has been fed from the paper loading unit 11. When it is determined that the print medium P has been fed from the second transport path 101, it is further determined whether the print data for the second surface of the print medium P on which the printing operations are being performed immediately before is the final print data in the one job. The following control is performed when it is determined that the print medium P to be cued has been fed from the second transport path 101 and the print data for the second surface of the print medium P on which the printing operations are being performed immediately before is the final print data in the one job. That is, the next print medium P after the print medium P to be cued is selected to be fed from the second transport path to the position opposite the print head 7. Additionally, the following control is performed when it is determined that the print medium P to be cued has been fed from the second transport path 101 and the print data for the second surface of the print medium P on which the printing operations are being performed immediately before is not the final print data in the one job. That is, the next print medium P after the print medium P to be cued is selected to be fed from the paper loading unit 11 to the position opposite the print head 7.

In this determination, it is determined that the second print medium P is fed from the second transport path 101 and the print data for the second surface of the third print medium P is the final print data in the one job. As such, the next print medium P after the second print medium P to be cued is fed from the second transport path 101 to the position opposite the print head 7. It is also necessary that the next print medium P after the second print medium P to be cued is not fed from the paper loading unit 11 at a delay. Furthermore, the second print medium P is being fed from the second transport path 101. Accordingly, in the cueing of the second print medium P, control is performed such that the first feed motor 206 is driven in reverse in the second drive switch state, and the feed roller 3 and the intermediate roller 15 are driven along with the transport roller 5 without driving the pickup roller 2.

Once the second print medium P is cued, the first feed motor 206 is switched to low-speed driving, while continuing to drive in reverse in the second drive switch state. In other words, the feed roller 3 and the intermediate roller rotate at 7.6 inches/sec. The second print medium P is transported intermittently by a predetermined amount at a time by the transport roller 5. Printing operations are performed on the second print medium P by the print head 7 based on the print data. When the second print medium P is transported intermittently for the printing operations, the third print medium P is also transported intermittently.

Descriptions will now be given with reference to ST26 in FIG. 10. After determining that the upstream-side end part of the third print medium P in the transport direction has passed the spur 12 based on the rotation amount of the transport roller 5 since the start of the cueing operations and the length of the sheets, the second feed motor 207 is rotated forward at high speed by the second feed motor driver 211. The reversing roller 9 is rotated at 18 inches/sec in the direction of the arrow A in FIG. 1. As a result, the speed at which the third print medium P is transported by the reversing roller 9 becomes faster than the speed at which the second print medium P is transported by the transport roller 5. The upstream-side end part of the third print medium P in the transport direction and the downstream-side leading end of the second print medium P in the transport direction no longer overlap. Then, after the third print medium P is reversed by the reversing roller 9, enters into the second transport path 101, and the upstream-side following end thereof in the transport direction passes the reversing roller 9, the downstream-side leading end of the second print medium P in the transport direction can pass the reversing roller 9. The “upstream-side following end of the third print medium P in the second transport path 101” means the downstream-side leading end in the first transport path 100 before the reversal.

When the reversing roller 9 rotates in the direction of the arrow A in STA in FIG. 1, the third print medium P is transported in the direction of the arrow C in STA in FIG. 1. As a result, the third print medium P is continuously transported until the upstream-side end part thereof in the transport direction reaches a predetermined position on the upstream side of the reversing roller 9 in the transport direction. Accordingly, the upstream-side end part of the third print medium P in the transport direction, and the downstream-side leading end of the second print medium P in the transport direction, which is being transported intermittently by a predetermined amount, are pulled apart.

Descriptions will now be given with reference to ST27 in FIG. 10. When the upstream-side end part of the third print medium P in the transport direction reaches the predetermined position on the upstream side of the reversing roller 9 in the transport direction, the second feed motor 207 is driven in reverse at high speed by the second feed motor driver 211. As a result, the reversing roller 9 and the intermediate roller 15 are rotated at 18 inches/sec in the direction of the arrow B in STC in FIG. 1. Then, the third print medium P is transported by the reversing roller 9 and the intermediate roller 15 along the guide within the second transport path (the reversing path) 101, until the downstream-side leading end thereof in the transport direction reaches a predetermined position before the first transport path 100. The predetermined position at this time is also calculated based on the rotation amount of the transport roller 5 since the start of the cueing operations and the length of the sheets.

Descriptions will now be given with reference to ST28 in FIG. 11. As the transport of the second print medium P progresses, the upstream-side end part of the second print medium P in the transport direction reaches a position corresponding to the timing at which the third print medium P starts being fed from the second transport path 101 by the intermediate roller 15 (described later). The first feed motor 206 is then driven in reverse at low speed by the first feed motor driver 210 in the second drive switch state. As a result, the intermediate roller 15 and the feed roller 3 are rotated at 7.6 inches/sec in the direction of the arrow B in STC in FIG. 1. Then, the third print medium P is transported by the intermediate roller 15 and the feed roller 3 from the second transport path 101 to the first transport path 100 in the direction of the transport roller 5. At this time, image forming operations are being performed on the second print medium P by the print head 7 based on the print data. When the downstream-side leading end of the third print medium P in the transport direction is sensed by the print medium sensor 16, the first feed motor 206 is switched to driving at high speed. while remaining in reverse, in the second drive switch state. In other words, the intermediate roller 15 and the feed roller 3 rotate at 20 inches/sec.

Similar to the conditions described earlier, at this time too, before the first feed motor 206 is switched to high-speed driving, the above-described values of the upstream-side end part of the preceding print medium P in the transport direction and the downstream-side leading end part of the following print medium P in the transport direction, stored in the RAM 203, are checked. In other words, the values of S(2), stored in the RAM 203 when printing onto the leading end part of the first surface of the second print medium P, and K(3), stored in the RAM 203 when printing onto the following end part of the first surface of the third print medium P, are checked. The “downstream-side leading end part of the third print medium P within the second transport path 101” means the upstream-side end part (the following end part) in the first transport path 100 before the reversal. If both S(2) and K(3) are 0, the first feed motor 206 is switched to high-speed driving. If either S(2) or K(3) is 1, the preceding print medium and the following print medium may not be able to overlap due to the print medium P curling. As such, the first feed motor 206 is not switched to high-speed driving. The descriptions will continue with a case where the values of S(2) and K(3) are 0 and the first feed motor 206 is switched to high-speed driving.

Moving the third print medium P at a higher speed than the speed at which the second print medium P is moved downstream as a result of the printing operations by the print head 7 makes it possible to create a state where the leading end part of the third print medium P overlaps the following end part of the second print medium P. The printing operations are performed based on the print data for the second print medium P, and thus the second print medium P is transported intermittently by the transport roller 5. On the other hand, continuously rotating the feed roller 3 and the intermediate roller 15 at 20 inches/sec after the leading end of the third print medium P is sensed by the print medium sensor 16 makes it possible for the third print medium P to catch up to the second print medium P. The third print medium P is then transported by the feed roller 3 until the downstream-side leading end thereof in the transport direction stops at a predetermined position upstream from the transport nip. The position of the downstream-side leading end of the third print medium P in the transport direction is calculated from the rotation amount of the feed roller 3 after the downstream-side leading end of the third print medium P in the transport direction is sensed by the print medium sensor 16, and is controlled based on the result of the calculation. At this time, image forming operations are being performed on the second print medium P by the print head 7 based on the print data.

Descriptions will now be given with reference to ST29 in FIG. 11. When the transport roller 5 is stopped to perform the image forming operations (ink ejection operations) for the final line of the second print medium P, the skew correction operations for the third print medium P are performed by driving the feed roller 3 to cause the downstream-side leading end of the third print medium P in the transport direction to contact the transport nip part. When the image forming operations for the final line of the second print medium P end, the third print medium P can be cued by rotating the transport roller 5 by a predetermined amount and keeping the third print medium P in a state of overlap on the second print medium P.

Once the skew correction operations for the third print medium P end, the transport roller 5 begins rotating as a result of being driven by the transport motor 205. The transport roller 5 transports the print medium at 15 inches/sec. After the third print medium P is cued to a position opposite the print head 7, the sixth page of print data is printed by the print head 7 ejecting ink based on the print data.

After determining that the upstream-side end part of the second print medium P in the transport direction has passed the spur 12 based on the rotation amount of the transport roller 5 since the start of the cueing operations and the length of the sheets, the second feed motor 207 is rotated forward at high speed by the second feed motor driver 211. The reversing roller 9 is rotated at 18 inches/sec in the direction of the arrow A in STA in FIG. 1. As a result, the speed at which the second print medium P is transported by the reversing roller 9 becomes faster than the speed at which the third print medium P is transported by the transport roller 5. The upstream-side end part of the second print medium P in the transport direction and the downstream-side leading end of the third print medium P in the transport direction no longer overlap. The printing onto the first surface and the second surface of the second print medium P is complete, and thus the second print medium P is discharged to the exterior of the apparatus by the reversing roller 9 rotating at 18 inches/sec in the direction of the arrow A in STA in FIG. 1.

When the image forming operations for the final line of the third print medium P end, the printing onto the first surface and the second surface of the third print medium P, which is the final print medium in the one job, ends. Accordingly, the reversing roller 9 is rotated at 18 inches/sec in the direction of the arrow A in STA in FIG. 1. The discharge roller 10 and the transport roller 5 are also rotated at 18 inches/sec in the same direction as the reversing roller 9, which discharges the third print medium P to the exterior of the apparatus and completes the double-sided printing.

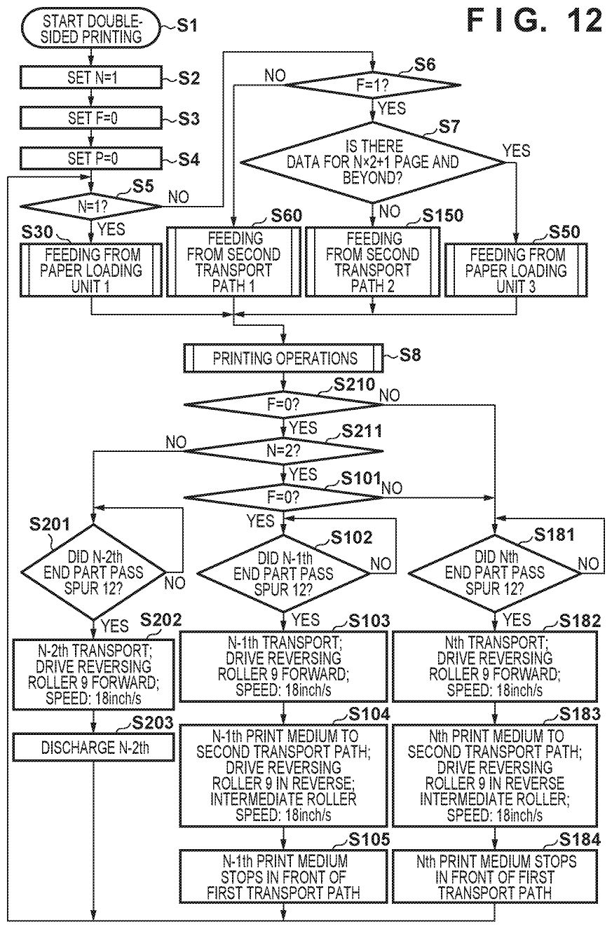

FIGS. 12 to 18 are flowcharts illustrating overlapping continuous feed operations in the double-sided printing mode according to the present embodiment. The following will describe a case where six pages' worth of print data are printed onto a first surface of a print medium P, which is the surface where printing operations are performed first, and a second surface, which is the back side of the first surface, for three sheets of the print medium P.

In step S1 in FIG. 12, when print data in the double-sided printing mode is transmitted from the host computer 214 via the I/F unit 213, the double-sided printing mode printing operations start.

In step S2, N=1 is stored in the RAM 203 as an initial value for managing how many sheets of the print medium P in the one job have been fed from the paper loading unit 11. In step S3, F=0 is stored in the RAM 203 as an initial value for managing whether the first surface or the second surface of the print medium P has been printed onto. Note that F=0 indicates printing onto the first surface, and F=1 indicates printing onto the second surface. In step S4, P=0 is stored in the RAM 203 as an initial value for managing whether the operations for feeding the print medium P to the position opposite the print head 7 were started from the paper loading unit 11 or the second transport path 101. Note that P=0 indicates feeding from the paper loading unit 11, and P=1 indicates feeding from the second transport path 101.

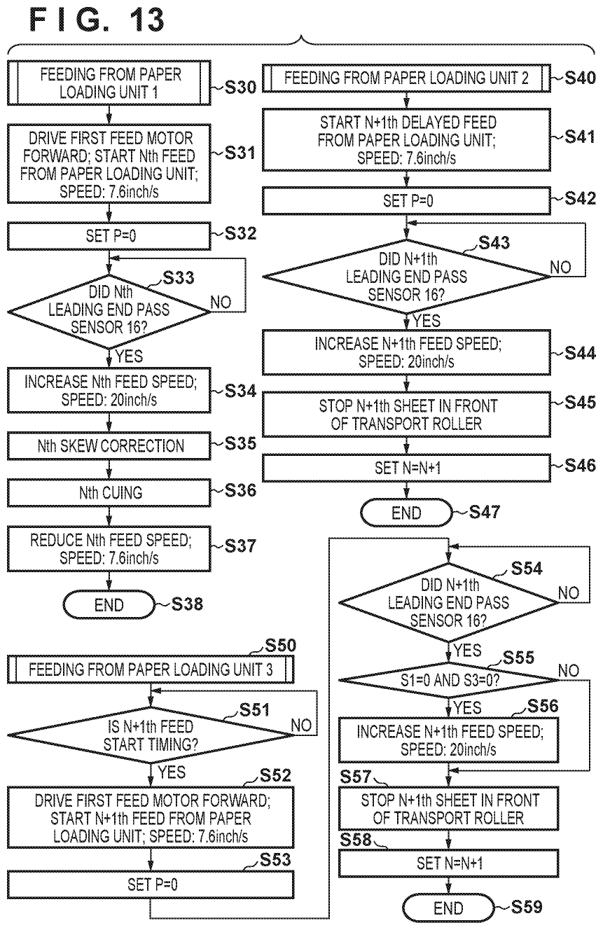

In step S5, when it is determined that the print medium P fed from the paper loading unit 11 is the first sheet in the job, the processing moves to the “feeding from paper loading unit 1” subroutine indicated in step S30 in FIG. 13.

In step S31, feeding operations for the first print medium P start from the paper loading unit 11. Specifically, the first feed motor 206 is driven forward at low speed. The pickup roller 2 rotates at 7.6 inches/sec. As a result, the first print medium P is picked up by the pickup roller 2, and is fed toward the print head 7 by the feed roller 3.

In step S32, P=0 is stored in the RAM 203 to store an indication that the print medium P has been fed from the paper loading unit 11. When in step S33 the downstream-side leading end of the first print medium P in the transport direction is sensed by the print medium sensor 16, in step S34, the first feed motor 206 is switched to driving at high speed. In other words, the pickup roller 2 and the feed roller 3 rotate at 20 inches/sec. The rotation amount of the feed roller 3 is controlled after the downstream-side leading end of the first print medium P in the transport direction is sensed by the print medium sensor 16. As a result, in step S35, the skew correction operations for the first print medium P are performed by causing the downstream-side leading end of the first print medium P in the transport direction to contact the transport nip part.

In step S36, the first print medium P is cued based on the print data. In other words, by controlling the rotation amount of the transport roller 5, the first print medium P is transported to a printing start position which takes the position of the transport roller 5, based on the print data, as a reference. In step S37, the first feed motor 206 is switched to low-speed driving. As a result, the pickup roller 2 and the feed roller 3 rotate at 7.6 inches/sec. In step S38, the “feeding from paper loading unit 1” subroutine ends, and the processing moves to the “printing operations” subroutine in step S8 in FIG. 12.

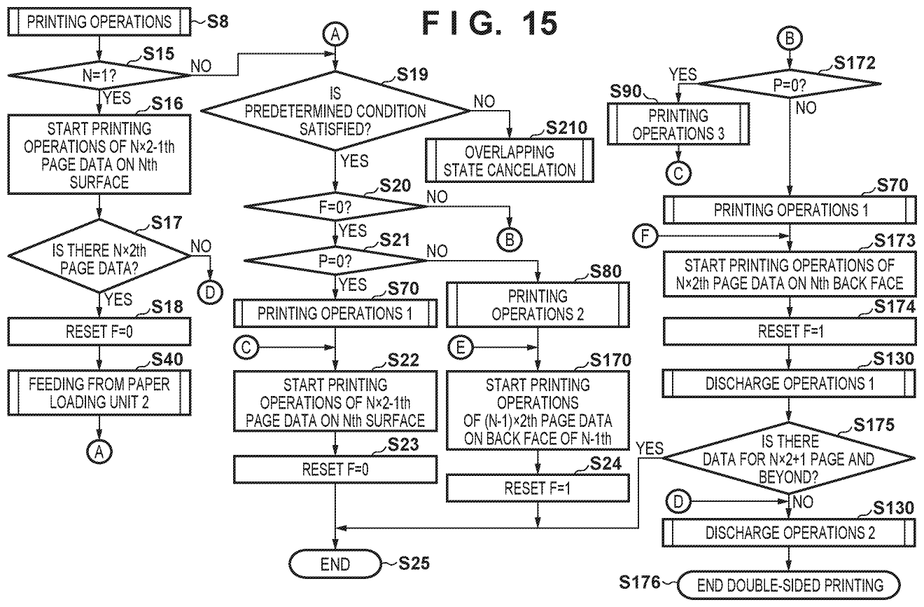

The “printing operations” subroutine will be described with reference to FIG. 15. When it is determined in step S15 that the number of sheets of the print medium P fed from the paper loading unit 11 in the one job is one sheet, in step S16, printing operations are performed for the first surface of the first print medium P by ejecting ink from the print head 7 based on the first page of print data. Specifically, transport operations in which the first print medium P is transported intermittently by the transport roller 5, and image forming operations (ink ejection operations) in which the carriage 1 is moved and ink is ejected from the print head 7, are repeated. As a result, printing operations are performed on the first surface of the first print medium P.

The first feed motor 206 is driven at low speed intermittently in synchronization with the operations for transporting the first print medium P intermittently by the transport roller 5. In other words, the pickup roller 2 and the feed roller 3 rotate intermittently at 7.6 inches/sec.

Here, the length of the print medium P in the transport direction is indicated by L, as illustrated in FIG. 25. The print density of the S region (a (¼) L part) at the leading end part of the first print medium P in the transport direction, at the current stage indicated by the arrow A, is compared with a pre-set print density. S(1)=0 is stored in the RAM 203 if, as a result of the comparison, the print density in the S region is within the pre-set print density, whereas S(1)=1 is stored if not. The number in the parentheses indicates the number of sheets printed.

Additionally, when the printing operations on the first print medium P progress, the print density of the K region (a (¼) L part) at the following end part of the first print medium in the transport direction, at the current stage indicated by the arrow A, is compared with a pre-set print density. K(1)=0 is stored in the RAM 203 if, as a result of the comparison, the print density in the K region is within the pre-set print density, whereas K(1)=1 is stored if not. The number in the parentheses indicates the number of sheets printed here as well.

Additionally, as illustrated in FIG. 26, when a number of printed sheets N of the print medium P becomes at least four, the value of N in S(N) and K(N) is converted to the value of M in the table, and is overwritten in the storage regions of S(M) and K(M) as needed.

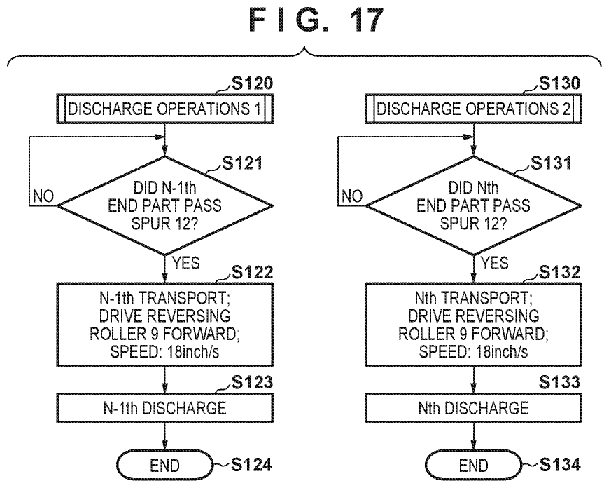

In step S17, it is determined whether there is a second page of print data. When it is determined that there is no second page of print data, in step S130, the processing moves to the “discharge operations 2” subroutine in FIG. 17.

In step S131, when it is determined that the upstream-side end part of the first print medium P in the transport direction has passed the spur 12 based on the rotation amount of the transport roller 5 since the start of the cueing operations and the length of the sheets, in step S132, the reversing roller 9 is continuously driven forward at 18 inches/sec. Then, in step S133, the first print medium P is discharged to the exterior of the apparatus, and in step S134, the “discharge operations 2” subroutine ends. Then, in step S176 in FIG. 15, the double-sided printing ends.

If it is determined in step S17 that there is a second page of print data, in step S18, F=0 is stored in the RAM 203 to store an indication that the printing operations have been performed on the first surface of the print medium P, and in step S40, the processing moves to the “feeding from paper loading unit 2” subroutine in FIG. 13.

In step S41, after the upstream-side end part of the first print medium P in the transport direction passes the pickup roller 2 and the drive shaft 19 has been driven for a predetermined length of time, the second print medium P is picked up. Specifically, the second print medium P is picked up from the paper loading unit 11 by the pickup roller 2 at 7.6 inches/sec (delayed feeding). In step S42, P=0 is stored in the RAM 203 to store an indication that the second print medium P has been fed from the paper loading unit 11.

When in step S43 the downstream-side leading end of the second print medium P in the transport direction is sensed by the print medium sensor 16, in step S44, the first feed motor 206 is switched to driving at high speed. In other words, the pickup roller 2 and the feed roller 3 rotate at 20 inches/sec. The rotation amount of the feed roller 3 is controlled after the downstream-side leading end of the second print medium P in the transport direction is sensed by the print medium sensor 16. As a result, in step S45, the second print medium P stops with the downstream-side leading end thereof in the transport direction at a position 10 mm before the transport nip part. Then, in step S46, 1 is added to N and N=2 is stored in the RAM 203 to store an indication that the second print medium P in the one job has been fed from the paper loading unit 11. In step S47, the “feeding from paper loading unit 2” subroutine ends, and the processing moves to step S19 in FIG. 15.

In step S19, it is determined whether a predetermined condition for causing the downstream-side leading end part of the following print medium P in the transport direction to overlap the upstream-side end part of the preceding print medium P in the transport direction is satisfied. The predetermined condition will be described later. If it is determined in step S19 that the predetermined condition is not satisfied, the processing moves to the “overlapping state cancelation” subroutine in step S210.

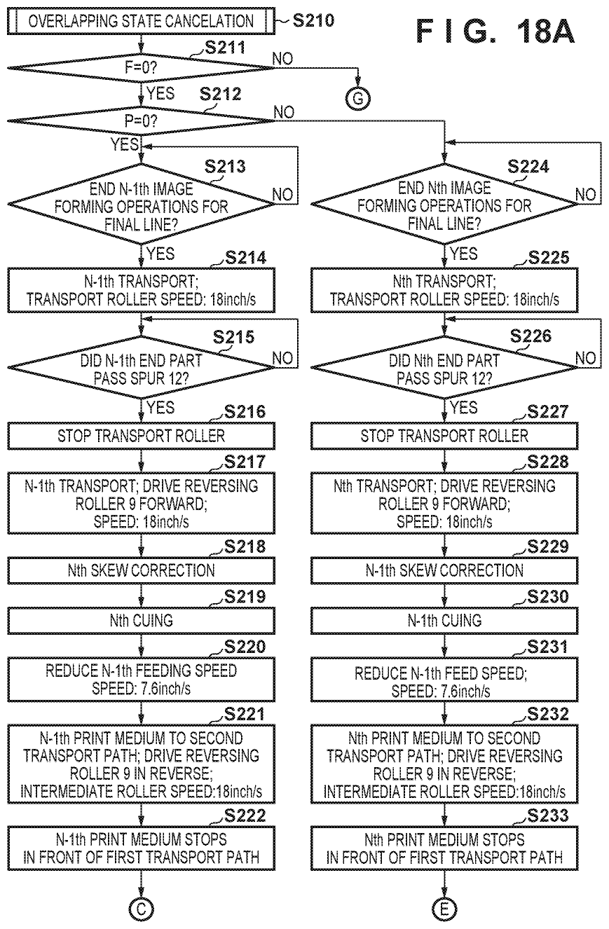

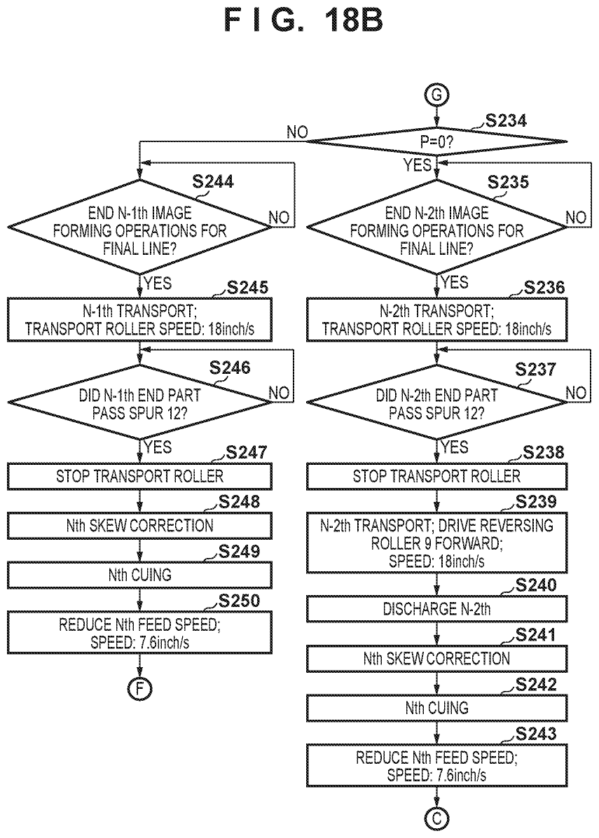

The “overlapping state cancelation” subroutine will be described with reference to FIGS. 18A and 18B. In step S211, the value of F in the RAM 203 is checked, and if F=0, i.e., if it is determined that printing is being performed on the first surface of the print medium P, it is determined, in step S212, whether the value of P stored in the RAM 203 is 0. Here, 0 is stored in step S42, and the processing therefore moves to step S213. When it is determined in step S213 that the image forming operations for the final line of the first print medium P are complete, in step S214, the first print medium P is transported at 18 inches/sec by the transport roller 5 and the discharge roller 10.

In step S215, when it is determined that the upstream-side end part of the first print medium P in the transport direction has passed the spur 12 based on the rotation amount of the transport roller 5 since the start of the cueing operations and the length of the sheets, in step S216, the driving of the transport motor 205 is stopped. The first feed motor 206 is not driven until the driving of the transport motor 205 stops, and thus the second print medium P remains stopped with the downstream-side leading end thereof in the transport direction at the position 10 mm before the transport nip part. Through this, the state of overlap between the first print medium P and the second print medium P is canceled. Additionally, by continuously driving the reversing roller 9 forward at 18 inches/sec in step S217, the first print medium P continues to be transported until the upstream-side end part thereof in the transport direction reaches a position 5 mm upstream from the nip part of the reversing roller 9 in the transport direction.

In step S218, the feed roller 3 is driven at 15 inches/sec to bring the leading end of the second print medium P into contact with the transport nip part and perform the skew correction operations for the second print medium P, and in step S219, the second print medium P is cued based on the print data. In other words, by controlling the rotation amount of the transport roller 5, the second print medium P is transported to a printing start position which takes the position of the transport roller 5, based on the print data, as a reference. Then, in step S220, the first feed motor 206 is switched to low-speed driving, and the feed roller 3 is rotated at 7.6 inches/sec.

In step S221, the reversing roller 9 and the intermediate roller 15 are driven continuously in reverse at 18 inches/sec. As a result, the first print medium P is transported by the reversing roller 9 and the intermediate roller 15 along the guide within the second transport path 101. Then, in step S222, the first print medium P is transported by the reversing roller 9 and the intermediate roller 15 until the downstream-side leading end thereof in the transport direction reaches a position 5 mm before the first transport path 100, and is then stopped. The processing then returns to step S22 in FIG. 15, and the processing from step S22 on is performed on the second print medium P.

If it is determined in step S19 that the predetermined condition is satisfied, in step S20, the value of F in the RAM 203 is checked, and if F=0, i.e., if it is determined that printing is being performed on the first surface of the print medium P, it is determined, in step S21, whether the value of P stored in the RAM 203 is 0. Here, 0 is stored in step S42, and the processing therefore moves to the “printing operations 1” subroutine in step S70.

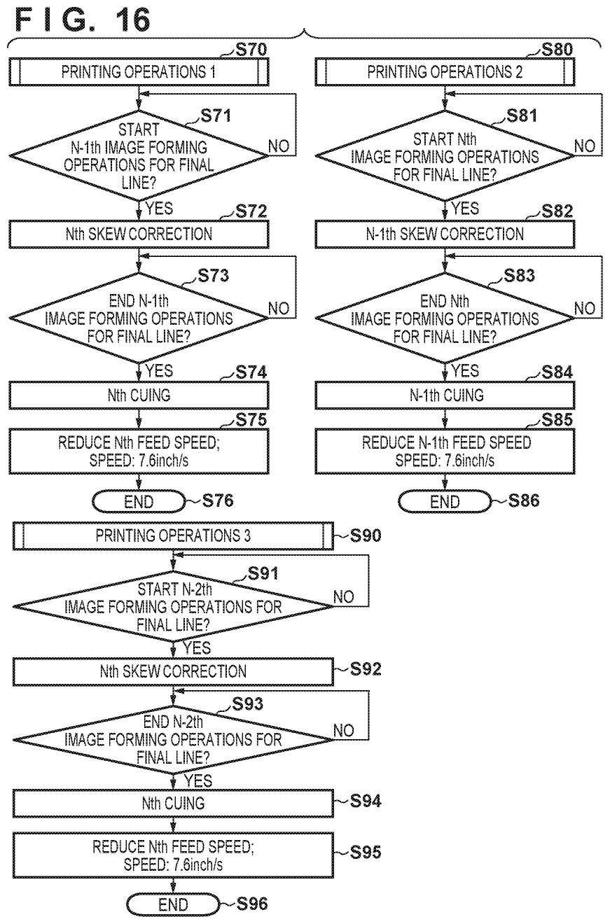

The “printing operations 1” subroutine will be described with reference to FIG. 16. In step S71, it is determined whether the image forming operations for the final line of the first print medium P have started. If the image forming operations have started, in step S72, the skew correction operations for the second print medium P are performed by causing the downstream-side leading end of the second print medium P in the transport direction to contact the transport nip part, with the state of overlap being maintained. Then, when it is determined in step S73 that the image forming operations for the final line of the first print medium P are complete, in step S74, the second print medium P is cued based on the print data while maintaining the state of overlap with the first print medium P. In other words, by controlling the rotation amount of the transport roller 5, the second print medium P is transported to a printing start position which takes the position of the transport roller 5, based on the print data, as a reference. The first feed motor 206 is switched to low-speed driving in step S75, the “printing operations 1” subroutine ends in step S76, and the processing returns to step S22 in the printing operations sequence in FIG. 15.

In step S22, the printing operations for the first surface of the second print medium P are started by ejecting ink from the print head 7 based on the third page of print data for the first surface of the second print medium P. Specifically, the printing operations for the first surface of the second print medium P are performed by repeating transport operations in which the second print medium P is transported intermittently by the transport roller 5, and image forming operations (ink ejection operations) in which the carriage 1 is moved and ink is ejected from the print head 7. Then, in step S23, F=0 is stored in the RAM 203 to store an indication that the printing operations have been performed on the first surface of the print medium P, and in step S25, the “printing operations” subroutine ends.

Here, as described earlier, the length of the print medium P in the transport direction is indicated by L, as illustrated in FIG. 25. When printing onto the first surface of the print medium P, which is printed first, the print density of an S region (a (¼) L part) at the leading end part in the transport direction, at the current stage indicated by the arrow A in FIG. 25, is compared with a pre-set print density. S(2)=0 is stored in the RAM 203 if, as a result of the comparison, the print density in the S region is within the pre-set print density, whereas S(2)=1 is stored if not. The number in the parentheses indicates the number of sheets printed.

Additionally, when the printing operations on the second print medium P progress, the print density of a K region (a (¼) L part) at the following end part in the transport direction, at the current stage indicated by the arrow A, is compared with a pre-set print density. K(2)=0 is stored in the RAM 203 if, as a result of the comparison, the print density in the K region is within the pre-set print density, whereas K(2)=1 is stored if not.

Additionally, as illustrated in FIG. 26, when a number of sheets N of the print medium P becomes at least four, the value of N in S(N) and K(N) is converted to the value of M in the table, and is overwritten in the storage regions of S(M) and K(M) as needed.

Returning to the overall sequence in FIG. 12, in step S210, it is determined whether F stored in the RAM 203 is 0. At the current stage, F=0, and thus in step S211, it is determined whether N stored in the RAM 203 is 2. At the current stage, N=2, and the processing therefore moves to step S101.

In step S101, it is determined whether the printing operations for the print medium P are for the first surface. Currently, the value of F in the RAM 203 is 0, and the printing operations for the print medium P are determined to be for the first surface, and the processing moves to step S102. When it is determined in step S102 that the upstream-side end part of the first print medium P in the transport direction has passed the spur 12, in step S103, the reversing roller 9 is continuously driven forward at 18 inches/sec. In the forward driving, the driving is performed continuously until the upstream-side end part of the first print medium P in the transport direction reaches a position 5 mm upstream from the nip part of the reversing roller 9 in the transport direction.

In step S104, the reversing roller 9 and the intermediate roller 15 are driven continuously in reverse at 18 inches/sec. As a result, the first print medium P is transported by the reversing roller 9 and the intermediate roller 15 along the guide within the second transport path 101. Then, in step S105, the first print medium P is transported by the reversing roller 9 and the intermediate roller 15 until the downstream-side leading end thereof in the transport direction reaches a position 5 mm before the first transport path 100, and is then stopped, after which the processing moves to step S5.

When it is determined in step S5 that the number of sheets of the print medium P fed from the paper loading unit 11 in the one job is not one (that N=2 at the current stage), it is determined in step S6 whether F in the RAM 203 is 1. F=0 at the current stage, and thus in step S60, the processing moves to the “feeding from second transport path 1” subroutine.

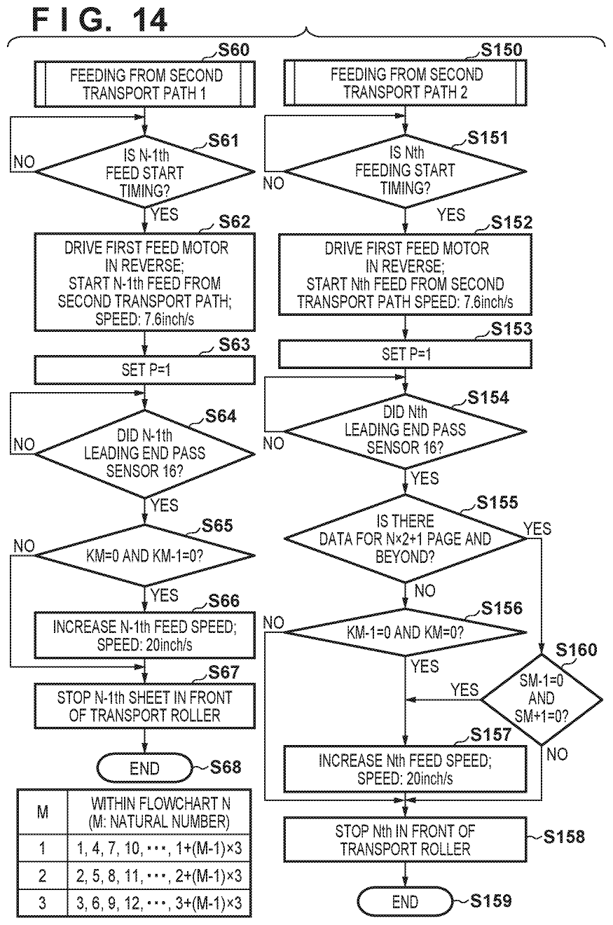

The “feeding from second transport path 1” subroutine will be described with reference to FIG. 14. In step S61, it is determined whether the timing at which the feeding of the first print medium P from the second transport path 101 by the intermediate roller 15 is started has been reached. When the print medium P on which printing operations are being performed by the print head 7 is fed from the paper loading unit 11 and the following print medium P is fed from the second transport path 101, the timing at which the feeding by the intermediate roller 15 is started is as follows. When, based on the rotation amount of the transport roller 5 since the start of cueing operations and the length of the paper, the upstream-side end part of the second print medium P in the transport direction and the downstream-side leading end of the first print medium P, which is standing by in the second transport path 101, in the transport direction, arrive at a positional relationship at a distance of 10 mm from each other, that time corresponds to the timing of the start of feeding. Based on this relationship, the driving of the intermediate roller 15 is started such that the feeding of the first print medium P from the second transport path 101 by the intermediate roller 15 is started.

In step S62, feeding operations for the first print medium P start from the second transport path 101. Specifically, the first feed motor 206 drives the second drive switch state at low speed in reverse. As a result, the intermediate roller 15 and the feed roller 3 are rotated at 7.6 inches/sec. The first print medium P is then fed toward the print head 7 by the intermediate roller 15 and the feed roller 3.

In step S63, P=1 is stored in the RAM 203 to store an indication that the print medium P has been fed from the second transport path 101. When in step S64 the downstream-side leading end of the first print medium P in the transport direction is sensed by the print medium sensor 16, in step S65, it is determined whether K(2)=0 and K(1)=0 in the RAM 203. Here, the first print medium P, which is the following print medium, has been reversed by the reversing roller 9 and is being transported by the second transport path 101. As such, the downstream-side leading end part of the first print medium serving as the following print medium, which overlaps the following end part of the second print medium P serving as the preceding print medium, is the upstream-side following end part in the first transport path 100 (the K region in FIG. 25). Accordingly, in step S65, it is determined whether K(2)=0 and K(1)=0 in the RAM 203.

If either is determined to be 1, the preceding print medium and the following print medium may not be able to overlap due to the print medium P curling, and thus the first feed motor 206 is not switched to high-speed driving.

Accordingly, the intermediate roller 15 and the feed roller 3 are driven, still at 7.6 inches/sec, in synchronization with the transport roller 5, and the processing moves to step S67. Then, in step S67, the rotation amount of the feed roller 3 is controlled after the downstream-side leading end of the first print medium P in the transport direction is sensed by the print medium sensor 16. As a result, the transport of the first print medium P stops when the downstream-side leading end of the first print medium P in the transport direction reaches a position 10 mm before the transport nip part. Then, in step S68, the “feeding from second transport path 1” subroutine ends.

When it is determined in step S65 that K(2)=0 and K(I)=0 in the RAM 203, in step S66, the first feed motor 206 is switched to high-speed driving. In other words, the intermediate roller 15 and the feed roller 3 rotate at 20 inches/sec. The rotation amount of the intermediate roller 15 and the feed roller 3 is controlled after the downstream-side leading end of the first print medium P in the transport direction is sensed by the print medium sensor 16. As a result, in step S67, the first print medium P stops with the downstream-side leading end of the first print medium P in the transport direction at a position 10 mm before the transport nip part. Then, in step S68, the “feeding from second transport path 1” subroutine ends, and the processing returns to the overall sequence in FIG. 12 and moves to the “printing operations” subroutine in step S8.

The “printing operations” subroutine will be described with reference to FIG. 15. When it is determined in step S15 that the number of sheets of the print medium P fed from the paper loading unit 11 in the one job is not one (that N=2 at the current stage), it is determined in step S19 whether a predetermined condition (described later) is satisfied. If it is determined in step S19 that the predetermined condition is not satisfied, the processing moves to the “overlapping state cancelation” subroutine in step S210.

The “overlapping state cancelation” subroutine will be described with reference to FIGS. 18A and 18B. In step S211, the value of F in the RAM 203 is checked, and if F=0, i.e., if it is determined that printing is being performed on the first surface of the print medium P, it is determined, in step S212, whether the value of P stored in the RAM 203 is 0. Here, 1 is stored in step S63, and the processing therefore moves to step S224. When it is determined in step S224 that the image forming operations for the final line of the second print medium P are complete, in step S225, the second print medium P is transported at 18 inches/sec by the transport roller 5 and the discharge roller 10.

In step S226, when it is determined that the upstream-side end part of the second print medium P in the transport direction has passed the spur 12 based on the rotation amount of the transport roller 5 since the start of the cueing operations and the length of the sheets, in step S227, the driving of the transport motor 205 is stopped. The first feed motor 206 is not driven until the driving of the transport motor 205 stops, and thus the first print medium P remains stopped with the downstream-side leading end thereof in the transport direction at the position 10 mm before the transport nip part. Through this, the state of overlap between the second print medium P and the first print medium P is canceled. Additionally, by continuously driving the reversing roller 9 forward at 18 inches/sec in step S228, the second print medium P continues to be transported until the upstream-side end part thereof in the transport direction reaches a position 5 mm upstream from the nip part of the reversing roller 9 in the transport direction.

In step S229, the feed roller 3 is driven at 15 inches/sec to bring the leading end of the first print medium P into contact with the transport nip part and perform the skew correction operations for the first print medium P, and in step S230, the first print medium P is cued based on the print data. In other words, by controlling the rotation amount of the transport roller 5, the first print medium P is transported to a printing start position which takes the position of the transport roller 5, based on the print data, as a reference. Then, in step S231, the first feed motor 206 is switched to low-speed driving, and the feed roller 3 is rotated at 7.6 inches/sec.

In step S232, the reversing roller 9 and the intermediate roller 15 are driven continuously in reverse at 18 inches/sec. As a result, the second print medium P is transported by the reversing roller 9 and the intermediate roller 15 along the guide within the second transport path 101. Then, in step S233, the second print medium P is transported by the reversing roller 9 and the intermediate roller 15 until the downstream-side leading end thereof in the transport direction reaches a position 5 mm before the first transport path 100, and is then stopped. The processing then returns to step S170 in FIG. 15, and the processing from step S170 on is performed on the first print medium P.

If it is determined in step S19 that the predetermined condition is satisfied, in step S20, the value of F in the RAM 203 is checked, and if F=0, i.e., if it is determined that printing is being performed on the first surface of the print medium P, it is determined, in step S21, whether the value of P stored in the RAM 203 is 0. 1 is stored at the current stage, and the processing therefore moves to the “printing operations 2” subroutine in step S80.

The “printing operations 2” subroutine will be described with reference to FIG. 16. In step S81, it is determined whether the image forming operations for the final line of the second print medium P have started. If the image forming operations have started, in step S82, the skew correction operations for the first print medium P are performed by causing the downstream-side leading end of the first print medium P in the transport direction to contact the transport nip part, with the state of overlap being maintained. Then, when it is determined in step S83 that the image forming operations for the final line of the second print medium P are complete, in step S84, the first print medium P is cued based on the print data while maintaining the state of overlap with the second print medium P. In other words, by controlling the rotation amount of the transport roller 5, the first print medium P is transported to a printing start position which takes the position of the transport roller 5, based on the print data, as a reference. The first feed motor 206 is switched to low-speed driving in step S85, the “printing operations 2” subroutine ends in step S86, and the processing returns to step S170 in the “printing operations” subroutine in FIG. 15.

In step S170, the printing operations for the second surface of the first print medium P are started by ejecting ink from the print head 7 based on the second page of print data. Specifically, the printing operations for the second surface of the first print medium P are performed by repeating transport operations in which the first print medium P is transported intermittently by the transport roller 5, and image forming operations (ink ejection operations) in which the carriage 1 is moved and ink is ejected from the print head 7. Then, in step S24, F=1 is stored in the RAM 203 to store an indication that the printing operations have been performed on the second surface of the print medium P, and in step S25, the “printing operations” subroutine ends.

Returning to the overall sequence in FIG. 12, in step S210, it is determined whether F stored in the RAM 203 is 0. F=1 at the current stage, and thus when it is determined in step S181 that the upstream-side end part of the second print medium P in the transport direction has passed the spur 12, in step S182, the reversing roller 9 is continuously driven forward at 18 inches/sec. In the forward driving, the driving is performed continuously until the upstream-side end part of the second print medium P in the transport direction reaches a position 5 mm upstream from the nip part of the reversing roller 9 in the transport direction.

In step S183, the reversing roller 9 and the intermediate roller 15 are driven continuously in reverse at 18 inches/sec. As a result, the second print medium P is transported by the reversing roller 9 and the intermediate roller 15 along the guide within the second transport path 101. Then, in step S184, the second print medium P is transported by the reversing roller 9 and the intermediate roller 15 until the downstream-side leading end thereof in the transport direction reaches a position 5 mm before the first transport path 100, and is then stopped, after which the processing moves to step S5.

When it is determined in step S5 that the number of sheets of the print medium P fed from the paper loading unit 11 in the one job is not one (that N=2 at the current stage), it is determined in step S6 whether F in the RAM 203 is 1. F=1 at the current stage, and thus it is determined in step S7 whether there is print data for a fifth page and beyond, and if there is such print data, the processing moves to the “feeding from paper loading unit 3” subroutine in step S50.

The “feeding from paper loading unit 3” subroutine will be described with reference to FIG. 13. In step S51, it is determined whether the timing at which the feeding of the third print medium P from the paper loading unit 11 by the pickup roller 2 is started has been reached. When the print medium P on which printing operations are being performed by the print head 7 is fed from the second transport path 101 and the following print medium P is fed from the paper loading unit 11, the timing at which the feeding by the pickup roller 2 is started is as follows. It is assumed that the first print medium P on which printing operations are being performed by the print head 7 is being transported in the first transport path 100. When the upstream-side end part of the first print medium P in the transport direction and the downstream-side leading end of the third print medium P, which is standing by in the paper loading unit 11, in the transport direction, are assumed to arrive at a positional relationship at a distance of 10 mm from each other based on the rotation amount of the transport roller 5 since the start of cueing operations and the length of the paper, that time corresponds to the timing of the start of feeding. Based on this relationship, the driving of the pickup roller 2 is started such that the feeding of the third print medium P from the paper loading unit 11 by the pickup roller 2 is started. When it is determined in step S51 that the timing for starting the feeding has been reached, in step S52, the third print medium P starts being fed from the paper loading unit 11 at 7.6 inches/sec by the pickup roller 2. In step S53, P=0 is stored in the RAM 203 to store an indication that the print medium P fed toward the print head 7 has been fed from the paper loading unit 11.

When in step S54 the downstream-side leading end of the third print medium P in the transport direction is sensed by the print medium sensor 16, in step S55, it is determined whether S(1)=0 and S(3)=0 in the RAM 203. Here, the first print medium P, which is the preceding print medium, has been reversed by the reversing roller 9 and is being transported by the second transport path 101. As such, the following end part of the first print medium P serving as the preceding print medium, which is overlapped by the leading end part of the third print medium serving as the following print medium, is the downstream-side leading end part in the first transport path 100 (the S region in FIG. 25). Accordingly, in step S55, it is determined whether S(1)=0 and S(3)=0 in the RAM 203.

If either is determined to be 1, the preceding print medium and the following print medium may not be able to overlap due to the print medium P curling, and thus the first feed motor 206 is not switched to high-speed driving. Accordingly, the pickup roller 2 and the feed roller 3 are driven, still at 7.6 inches/sec, in synchronization with the transport roller 5, and the processing moves to step S57. Then, in step S57, the rotation amount of the feed roller 3 is controlled after the downstream-side leading end of the third print medium P in the transport direction is sensed by the print medium sensor 16. As a result, the transport of the third print medium P stops when the downstream-side leading end of the third print medium P in the transport direction reaches a position 10 mm before the transport nip part. Then, in step S58, 1 is added to the value of N in the RAM 203 for N=3, and in step S59, the “feeding from paper loading unit 3” subroutine ends.

When it is determined in step S55 that S(1)=0 and S(3)=0 in the RAM 203, in step S56, the first feed motor 206 is switched to high-speed driving. In other words, the pickup roller 2 and the feed roller 3 rotate at 20 inches/sec. The rotation amount of the feed roller 3 is then controlled after the downstream-side leading end of the third print medium P in the transport direction is sensed by the print medium sensor 16. As a result, in step S57, the third print medium P is transported such that the downstream-side leading end of the third print medium P in the transport direction arrives at a position 10 mm before the transport nip part. The first print medium P is transported intermittently based on the print data. By driving the first feed motor 206 continuously at high speed, a state is created in which the vicinity of the downstream-side leading end part of the third print medium P in the transport direction overlaps with the vicinity of the upstream end part of the first print medium P in the transport direction. In step S58, 1 is added to the value of N in the RAM 203 for N=3, and in step S59, the “feeding from paper loading unit 3” subroutine ends. The processing then returns to the overall sequence in FIG. 12 and moves to the “printing operations” subroutine in step S8.

The “printing operations” subroutine will be described with reference to FIG. 15. When it is determined in step S15 that the number of sheets of the print medium P fed from the paper loading unit 11 in the one job is not one (that N=3 at the current stage), it is determined in step S19 whether a predetermined condition (described later) is satisfied. If it is determined in step S19 that the predetermined condition is not satisfied, the processing moves to the overlapping state cancelation subroutine in step S210.

The “overlapping state cancelation” subroutine will be described with reference to FIGS. 18A and 18B. In step S211, the value of F in the RAM 203 is checked, and if F=1, i.e., if it is determined that printing is being performed on the second surface of the print medium P, it is determined, in step S234, whether the value of P stored in the RAM 203 is 0. 0 is stored at the current stage, and the processing therefore moves to step S235. When it is determined in step S235 that the image forming operations for the final line of the first print medium P are complete, in step S236, the first print medium P is transported at 18 inches/sec by the transport roller 5 and the discharge roller 10.

In step S237, when it is determined that the upstream-side end part of the first print medium P in the transport direction has passed the spur 12 based on the rotation amount of the transport roller 5 since the start of the cueing operations and the length of the sheets, in step S238, the driving of the transport motor 205 is stopped. The first feed motor 206 is not driven until the driving of the transport motor 205 stops, and thus the third print medium P remains stopped with the downstream-side leading end thereof in the transport direction at the position 10 mm before the transport nip part. Through this, the state of overlap between the first print medium P and the third print medium P is canceled. Additionally, by continuously driving the reversing roller 9 forward at 18 inches/sec in step S239, the first print medium P is discharged to the exterior of the apparatus in step S240.

In step S241, the feed roller 3 is driven at 15 inches/sec to bring the leading end of the third print medium P into contact with the transport nip part and perform the skew correction operations for the third print medium P, and in step S242, the third print medium P is cued based on the print data. In other words, by controlling the rotation amount of the transport roller 5, the third print medium P is transported to a printing start position which takes the position of the transport roller 5, based on the print data, as a reference. Then, in step S243, the first feed motor 206 is switched to low-speed driving, and the feed roller 3 is rotated at 7.6 inches/sec. The processing then returns to step S22 in FIG. 15, and the processing from step S22 on is performed on the third print medium P.

If it is determined in step S19 that the predetermined condition is satisfied, in step S20, the value of F in the RAM 203 is checked, and if F=1, i.e., if it is determined that printing is being performed on the second surface of the print medium P, it is determined, in step S172, whether the value of P stored in the RAM 203 is 0. 0 is stored at the current stage, and the processing therefore moves to the “printing operations 3” subroutine in step S90.

The “printing operations 3” subroutine will be described with reference to FIG. 16. In step S91, it is determined whether the image forming operations for the final line of the first print medium P have started. If the image forming operations have started, in step S92, the skew correction operations for the third print medium P are performed by causing the downstream-side leading end of the third print medium P in the transport direction to contact the transport nip part, with the state of overlap being maintained. Then, when it is determined in step S93 that the image forming operations for the final line of the first print medium P are complete, in step S94, the third print medium P is cued based on the print data while maintaining the state of overlap with the third print medium P. In other words, by controlling the rotation amount of the transport roller 5, the third print medium P is transported to a printing start position which takes the position of the transport roller 5, based on the print data, as a reference. The first feed motor 206 is switched to low-speed driving in step S95, the “printing operations 3” subroutine ends in step S96, and the processing returns to step S22 in the “printing operations” subroutine in FIG. 15.

In step S22, the printing operations for the first surface of the third print medium P are started by ejecting ink from the print head 7 based on the fifth page of print data. Specifically, the printing operations for the first surface of the third print medium P are performed by repeating transport operations in which the third print medium P is transported intermittently by the transport roller 5, and image forming operations (ink ejection operations) in which the carriage 1 is moved and ink is ejected from the print head 7. Then, in step S23, F=0 is stored in the RAM 203 to store an indication that the printing operations have been performed on the first surface of the print medium P, and in step S25, the “printing operations” subroutine ends.

Here, as described earlier, the length of the print medium P in the transport direction is indicated by L, as illustrated in FIG. 25. When printing onto the first surface of the print medium P, which is printed first, the print density of an S region (a (¼) L part) at the leading end part in the transport direction, at the current stage indicated by the arrow A in FIG. 25, is compared with a pre-set print density. S(3)=0 is stored in the RAM 203 if, as a result of the comparison, the print density in the S region is within the pre-set print density, whereas S(3)=1 is stored if not. The number in the parentheses indicates the number of sheets printed.

Additionally, when the printing operations on the third print medium P progress, the print density of a K region (a (¼) L part) at the following end part in the transport direction, at the current stage indicated by the arrow A, is compared with a pre-set print density. K(3)=0 is stored in the RAM 203 if, as a result of the comparison, the print density in the K region is within the pre-set print density, whereas K(3)=1 is stored if not.

Additionally, as illustrated in FIG. 26, when a number of sheets N of the print medium P becomes at least four, the value of N in S(N) and K(N) is converted to the value of M in the table, and is overwritten in the storage regions of S(M) and K(M) as needed.

Returning to the overall sequence in FIG. 12, in step S210, it is determined whether F stored in the RAM 203 is 0. At the current stage, F=0, and thus in step S211, it is determined whether N stored in the RAM 203 is 2. The value is 3 at the current stage, and thus in step S201, it is determined that the upstream-side end part of the first print medium P in the transport direction has passed the spur 12 based on the rotation amount of the transport roller 5 since the start of the cueing operations and the length of the sheets. When it is determined that this end has passed, in step S202, the reversing roller 9 is continuously driven forward at 18 inches/sec. In step S203, the first print medium P is discharged to the exterior of the apparatus, and the processing moves to step S5.

When it is determined in step S5 that the number of sheets of the print medium P fed from the paper loading unit 11 in the one job is not one (that N=3 at the current stage), it is determined in step S6 whether F in the RAM 203 is 1. F=0 at the current stage, and thus in step S60, the processing moves to the “feeding from second transport path 1” subroutine.

The “feeding from second transport path 1” subroutine will be described with reference to FIG. 14. In step S61, it is determined whether the timing at which the feeding of the second print medium P from the second transport path 101 by the intermediate roller 15 is started has been reached. When the print medium P on which printing operations are being performed by the print head 7 is fed from the paper loading unit 11 and the following print medium P is fed from the second transport path 101, the timing at which the feeding by the intermediate roller 15 is started is as follows. When, based on the rotation amount of the transport roller 5 since the start of cueing operations and the length of the paper, the upstream-side end part of the third print medium P in the transport direction and the downstream-side leading end of the second print medium P, which is standing by in the second transport path 101, in the transport direction, arrive at a positional relationship at a distance of 10 mm from each other, that time corresponds to the timing of the start of feeding. Based on this relationship, the driving of the intermediate roller 15 is started such that the feeding of the second print medium P from the second transport path 101 by the intermediate roller 15 is started.

In step S62, feeding operations for the second print medium P start from the second transport path 101. Specifically, the first feed motor 206 drives the second drive switch state at low speed in reverse. As a result, the intermediate roller 15 and the feed roller 3 are rotated at 7.6 inches/sec. The second print medium P is then fed toward the print head 7 by the intermediate roller 15 and the feed roller 3.

In step S63, P=1 is stored in the RAM 203 to store an indication that the print medium P has been fed from the second transport path 101. When in step S64 the downstream-side leading end of the second print medium P in the transport direction is sensed by the print medium sensor 16, in step S65, it is determined whether K(3)=0 and K(2)=0 in the RAM 203. Here, the second print medium P, which is the following print medium, has been reversed by the reversing roller 9 and is being transported by the second transport path 101. As such, the downstream-side leading end part of the second print medium serving as the following print medium, which overlaps the following end part of the third print medium P serving as the preceding print medium, is the upstream-side following end part in the first transport path 100 (the K region in FIG. 25). Accordingly, in step S65, it is determined whether K(3)=0 and K(2)=0 in the RAM 203.

If either is determined to be 1, the preceding print medium and the following print medium may not be able to overlap due to the print medium P curling, and thus the first feed motor 206 is not switched to high-speed driving. Accordingly, the intermediate roller 15 and the feed roller 3 are driven, still at 7.6 inches/sec, in synchronization with the transport roller 5, and the processing moves to step S67.

Then, in step S67, the rotation amount of the feed roller 3 is controlled after the downstream-side leading end of the second print medium P in the transport direction is sensed by the print medium sensor 16. As a result, the transport of the second print medium P stops when the downstream-side leading end of the second print medium P in the transport direction reaches a position 10 mm before the transport nip part. Then, in step S68, the “feeding from second transport path 1” subroutine ends.

When it is determined in step S65 that K(3)=0 and K(2)=0 in the RAM 203, in step S66, the first feed motor 206 is switched to high-speed driving. In other words, the intermediate roller 15 and the feed roller 3 rotate at 20 inches/sec. The rotation amount of the intermediate roller 15 and the feed roller 3 is controlled after the downstream-side leading end of the second print medium P in the transport direction is sensed by the print medium sensor 16. As a result, in step S67, the second print medium P stops with the downstream-side leading end of the second print medium P in the transport direction at a position 10 mm before the transport nip part. Then, in step S68, the “feeding from second transport path 1” subroutine ends, and the processing returns to the overall sequence in FIG. 12 and moves to the printing operations subroutine in step S8.

The “printing operations” subroutine will be described with reference to FIG. 15. When it is determined in step S15 that the number of sheets of the print medium P fed from the paper loading unit 11 in the one job is not one (that N=3 at the current stage), it is determined in step S19 whether a predetermined condition (described later) is satisfied. If it is determined in step S19 that the predetermined condition is not satisfied, the processing moves to the overlapping state cancelation subroutine in step S210.

The “overlapping state cancelation” subroutine will be described with reference to FIGS. 18A and 18B. In step S211, the value of F in the RAM 203 is checked, and if F=0, i.e., if it is determined that printing is being performed on the first surface of the print medium P, it is determined, in step S212, whether the value of P stored in the RAM 203 is 0. 1 is stored at the current stage, and the processing therefore moves to step S224. When it is determined in step S224 that the image forming operations for the final line of the third print medium P are complete, in step S225, the third print medium P is transported at 18 inches/sec by the transport roller 5 and the discharge roller 10. In step S226, when it is determined that the upstream-side end part of the third print medium P in the transport direction has passed the spur 12 based on the rotation amount of the transport roller 5 since the start of the cueing operations and the length of the sheets, in step S227, the driving of the transport motor 205 is stopped. The first feed motor 206 is not driven until the driving of the transport motor 205 stops, and thus the second print medium P remains stopped with the downstream-side leading end thereof in the transport direction at the position 10 mm before the transport nip part. Through this, the state of overlap between the third print medium P and the second print medium P is canceled. Additionally, by continuously driving the reversing roller 9 forward at 18 inches/sec in step S228, the third print medium P continues to be transported until the upstream-side end part thereof in the transport direction reaches a position 5 mm upstream from the nip part of the reversing roller 9 in the transport direction.

In step S229, the feed roller 3 is driven at 15 inches/sec to bring the leading end of the second print medium P into contact with the transport nip part and perform the skew correction operations for the second print medium P, and in step S230, the second print medium P is cued based on the print data. In other words, by controlling the rotation amount of the transport roller 5, the second print medium P is transported to a printing start position which takes the position of the transport roller 5, based on the print data, as a reference. Then, in step S231, the first feed motor 206 is switched to low-speed driving, and the feed roller 3 is rotated at 7.6 inches/sec.

In step S232, the reversing roller 9 and the intermediate roller 15 are driven continuously in reverse at 18 inches/sec. As a result, the third print medium P is transported by the reversing roller 9 and the intermediate roller 15 along the guide within the second transport path 101. Then, in step S233, the third print medium P is transported by the reversing roller 9 and the intermediate roller 15 until the downstream-side leading end thereof in the transport direction reaches a position 5 mm before the first transport path 100, and is then stopped. The processing then returns to step S170 in FIG. 15, and the processing from step S170 on is performed on the second print medium P.

If it is determined in step S19 that the predetermined condition is satisfied, in step S20, the value of F in the RAM 203 is checked, and if F=0, i.e., if it is determined that printing is being performed on the first surface of the print medium P, it is determined, in step S21, whether the value of P stored in the RAM 203 is 0. 1 is stored at the current stage, and the processing therefore moves to the “printing operations 2” subroutine in step S80.

The “printing operations 2” subroutine will be described with reference to FIG. 16. In step S81, it is determined whether the image forming operations for the final line of the third print medium P have started. If the image forming operations have started, in step S82, the skew correction operations for the second print medium P are performed by causing the downstream-side leading end of the second print medium P in the transport direction to contact the transport nip part, with the state of overlap being maintained. Then, when it is determined in step S83 that the image forming operations for the final line of the third print medium P are complete, in step S84, the second print medium P is cued based on the print data while maintaining the state of overlap with the third print medium P. In other words, by controlling the rotation amount of the transport roller 5, the second print medium P is transported to a printing start position which takes the position of the transport roller 5, based on the print data, as a reference. The first feed motor 206 is switched to low-speed driving in step S85, the “printing operations 2” subroutine ends in step S86, and the processing returns to step S170 in the “printing operations” subroutine in FIG. 15.

In step S170, the printing operations for the second surface of the second print medium P are started by ejecting ink from the print head 7 based on the fourth page of print data. Specifically, the printing operations for the second surface of the second print medium P are performed by repeating transport operations in which the second print medium P is transported intermittently by the transport roller 5, and image forming operations (ink ejection operations) in which the carriage 1 is moved and ink is ejected from the print head 7. Then, in step S24, F=1 is stored in the RAM 203 to store an indication that the printing operations have been performed on the second surface of the print medium P, and in step S25, the printing operations subroutine ends.

Returning to the overall sequence in FIG. 12, in step S210, it is determined whether F stored in the RAM 203 is 0. F=1 at the current stage, and thus when it is determined in step S181 that the upstream-side end part of the third print medium P in the transport direction has passed the spur 12, in step S182, the reversing roller 9 is continuously driven forward at 18 inches/sec. In the forward driving, the driving is performed continuously until the upstream-side end part of the third print medium P in the transport direction reaches a position 5 mm upstream from the nip part of the reversing roller 9 in the transport direction.

In step S183, the reversing roller 9 and the intermediate roller 15 are driven continuously in reverse at 18 inches/sec. As a result, the third print medium P is transported by the reversing roller 9 and the intermediate roller 15 along the guide within the second transport path 101. Then, in step S184, the third print medium P is transported by the reversing roller 9 and the intermediate roller 15 until the downstream-side leading end thereof in the transport direction reaches a position 5 mm before the first transport path 100, and is then stopped, after which the processing moves to step S5.

When it is determined in step S5 that the number of sheets of the print medium P fed from the paper loading unit 11 in the one job is not one (that N=3 at the current stage), it is determined in step S6 whether F in the RAM 203 is 1. F=1 at the current stage, and thus in step S7, it is determined whether there is print data for a seventh page and beyond. In the present embodiment, there is no such print data, and thus in step S150, the processing moves to the “feeding from second transport path 2” subroutine.

The “feeding from second transport path 2” subroutine will be described with reference to FIG. 14. In step S151, it is determined whether the timing at which the feeding of the third print medium P from the second transport path 101 by the intermediate roller 15 is started has been reached. When the print medium P on which printing operations are being performed by the print head 7 is fed from the second transport path 101 and the following print medium P is also fed from the second transport path 101, the timing at which the feeding by the intermediate roller 15 is started is as follows. When, based on the rotation amount of the transport roller 5 since the start of cueing operations and the length of the paper, the upstream-side end part of the second print medium P in the transport direction and the downstream-side leading end of the third print medium P, which is within the second transport path 101, in the transport direction, arrive at a positional relationship at a distance of 10 mm from each other, that time corresponds to the timing of the start of feeding. Based on this relationship, the driving of the intermediate roller 15 is started such that the feeding of the third print medium P from the second transport path 101 by the intermediate roller 15 is started. In step S152, feeding operations for the third print medium P start from the second transport path 101. Specifically, the first feed motor 206 drives the second drive switch state at low speed in reverse. As a result, the intermediate roller 15 and the feed roller 3 are rotated at 7.6 inches/sec. The third print medium P is then fed toward the print head 7 by the intermediate roller 15 and the feed roller 3. In step S153, P=1 is stored in the RAM 203 to store an indication that the print medium P has been fed from the second transport path 101.

When in step S154 the downstream-side leading end of the third print medium P in the transport direction is sensed by the print medium sensor 16, in step S155, it is determined whether there is print data for a seventh page and beyond. Although there is no print data for the seventh page and beyond in the present embodiment, a case where there is such print data will be described below.

When it is determined in step S155 that there is print data for a seventh page and beyond, the processing moves to step S160, and in step S160, it is determined whether S(2)=0 and S(4)=0 are stored in the RAM 203. If either is determined to be 1, the preceding print medium and the following print medium may not be able to overlap due to the print medium P curling, and thus the first feed motor 206 is not switched to high-speed driving. Accordingly, the intermediate roller 15 and the feed roller 3 are driven, still at 7.6 inches/sec, in synchronization with the transport roller 5, and the processing moves to step S158.

Then, in step S158, the rotation amount of the feed roller 3 is controlled after the downstream-side leading end of the fourth print medium P in the transport direction is sensed by the print medium sensor 16. As a result, the transport of the fourth print medium P stops when the downstream-side leading end of the fourth print medium P in the transport direction reaches a position 10 mm before the transport nip part. Then, in step S159, the “feeding from second transport path 2” subroutine ends, and the processing returns to the overall sequence in FIG. 12 and moves to the printing operations subroutine in step S8.

When it is determined in step S160 that S(2)=0 and K(4)=0 in the RAM 203, in step S157, the first feed motor 206 is switched to high-speed driving. In other words, the intermediate roller 15 and the feed roller 3 rotate at 20 inches/sec. The rotation amount of the intermediate roller 15 and the feed roller 3 is controlled after the downstream-side leading end of the fourth print medium P in the transport direction is sensed by the print medium sensor 16. As a result, in step S158, the fourth print medium P stops with the downstream-side leading end of the fourth print medium P in the transport direction at a position 10 mm before the transport nip part. Then, in step S159, the “feeding from second transport path 2” subroutine ends, and the processing returns to the overall sequence in FIG. 12 and moves to the printing operations subroutine in step S8.

In the present embodiment, there is no print data for a seventh page and beyond, and thus when it is determined in step S155 that there is no print data for a seventh page and beyond, the processing moves to step S156, where it is determined whether K(2)=0 and K(3)=0 are stored in the RAM 203. If either is determined to be 1, the preceding print medium and the following print medium may not be able to overlap due to the print medium P curling, and thus the first feed motor 206 is not switched to high-speed driving. Accordingly, the intermediate roller 15 and the feed roller 3 are driven, still at 7.6 inches/sec, in synchronization with the transport roller 5, and the processing moves to step S158.

Then, in step S158, the rotation amount of the feed roller 3 is controlled after the downstream-side leading end of the third print medium P in the transport direction is sensed by the print medium sensor 16. As a result, the transport of the third print medium P stops when the downstream-side leading end of the third print medium P in the transport direction reaches a position 10 mm before the transport nip part. Then, in step S159, the “feeding from second transport path 2” subroutine ends.

When it is determined in step S160 that K(2)=0 and K(3)=0 in the RAM 203, in step S157, the first feed motor 206 is switched to high-speed driving. In other words, the intermediate roller 15 and the feed roller 3 rotate at 20 inches/sec. The rotation amount of the intermediate roller 15 and the feed roller 3 is controlled after the downstream-side leading end of the third print medium P in the transport direction is sensed by the print medium sensor 16. As a result, in step S158, the third print medium P stops with the downstream-side leading end of the third print medium P in the transport direction at a position 10 mm before the transport nip part. Then, in step S159, the “feeding from second transport path 2” subroutine ends, and the processing returns to the overall sequence in FIG. 12 and moves to the “printing operations” subroutine in step S8.

The “printing operations” subroutine will be described with reference to FIG. 15. When it is determined in step S15 that the number of sheets of the print medium P fed from the paper loading unit 11 in the one job is not one (that N=3 at the current stage), it is determined in step S19 whether a predetermined condition (described later) is satisfied. If it is determined in step S19 that the predetermined condition is not satisfied, the processing moves to the “overlapping state cancelation” subroutine in step S210.

The “overlapping state cancelation” subroutine will be described with reference to FIGS. 18A and 18B. In step S211, the value of F in the RAM 203 is checked, and if F=1, i.e., if it is determined that printing is being performed on the second surface of the print medium P, it is determined, in step S234, whether the value of P stored in the RAM 203 is 0. 1 is stored at the current stage, and the processing therefore moves to step S244.

When it is determined in step S244 that the image forming operations for the final line of the second print medium P are complete, in step S245, the second print medium P is transported at 18 inches/sec b y the transport roller 5 and the discharge roller 10. In step S246, when it is determined that the upstream-side end part of the second print medium P in the transport direction has passed the spur 12 based on the rotation amount of the transport roller 5 since the start of the cueing operations and the length of the sheets, in step S247, the driving of the transport motor 205 is stopped. The first feed motor 206 is not driven until the driving of the transport motor 205 stops, and thus the third print medium P remains stopped with the downstream-side leading end thereof in the transport direction at the position 10 mm before the transport nip part. Through this, the state of overlap between the second print medium P and the third print medium P is canceled.

In step S248, the feed roller 3 is driven at 15 inches/sec to bring the leading end of the third print medium P into contact with the transport nip part and perform the skew correction operations for the third print medium P, and in step S249, the third print medium P is cued based on the print data. In other words, by controlling the rotation amount of the transport roller 5, the third print medium P is transported to a printing start position which takes the position of the transport roller 5, based on the print data, as a reference. Then, in step S250, the first feed motor 206 is switched to low-speed driving, and the feed roller 3 is rotated at 7.6 inches/sec.

The processing then returns to step S173 in FIG. 15, and the processing from step S173 on is performed on the third print medium P and the second print medium P.

If it is determined in step S19 that the predetermined condition is satisfied, in step S20, the value of F in the RAM 203 is checked, and if F=1, i.e., if it is determined that printing is being performed on the second surface of the print medium P, it is determined, in step S172, whether the value of P stored in the RAM 203 is 0. 1 is stored at the current stage, and the processing therefore moves to the “printing operations 1” subroutine in step S70.

The “printing operations 1” subroutine will be described with reference to FIG. 16. In step S71, it is determined whether the image forming operations for the final line of the second print medium P have started. If the image forming operations have started, in step S72, the skew correction operations for the third print medium P are performed by causing the downstream-side leading end of the third print medium P in the transport direction to contact the transport nip part, with the state of overlap being maintained. Then, when it is determined in step S73 that the image forming operations for the final line of the second print medium P are complete, in step S74, the third print medium P is cued based on the print data while maintaining the state of overlap with the second print medium P. In other words, by controlling the rotation amount of the transport roller 5, the third print medium P is transported to a printing start position which takes the position of the transport roller 5, based on the print data, as a reference. The first feed motor 206 is switched to low-speed driving in step S75, the “printing operations 1” subroutine ends in step S76, and the processing returns to step S173 in the “printing operations” sequence in FIG. 15.

In step S173, the printing operations for the second surface of the third print medium P are started by ejecting ink from the print head 7 based on the sixth page of print data. Specifically, the printing operations for the second surface of the third print medium P are performed by repeating transport operations in which the third print medium P is transported intermittently by the transport roller 5, and image forming operations (ink ejection operations) in which the carriage 1 is moved and ink is ejected from the print head 7. Then, in step S174, F=1 is stored in the RAM 203 to store an indication that the printing operations have been performed on the second surface of the print medium P, and the processing then moves to the “discharge operations 1” subroutine in step S130.

The “discharge operations 1” subroutine will be described with reference to FIG. 17. In step S121, when it is determined that the upstream-side end part of the second print medium P in the transport direction has passed the spur 12 based on the rotation amount of the transport roller 5 since the start of the cueing operations and the length of the sheets, in step S122, the reversing roller 9 is continuously driven forward at 18 inches/sec. Then, in step S123, the second print medium P is discharged to the exterior of the apparatus, and in step S124, the “discharge operations 1” subroutine ends. The processing then returns to step S175 in the “printing operations” subroutine in FIG. 15, it is determined in step S175 whether there is print data for a seventh page and beyond, and when it is determined that there is no such print data, the processing moves to the “discharge operations 2” subroutine in step S130.

The “discharge operations 2” subroutine will be described with reference to FIG. 17. In step S131, when it is determined that the upstream-side end part of the third print medium P in the transport direction has passed the spur 12 based on the rotation amount of the transport roller 5 since the start of the cueing operations and the length of the sheets, in step S132, the reversing roller 9 is continuously driven forward at 18 inches/sec. Then, in step S133, the third print medium P is discharged to the exterior of the apparatus, and in step S134, the “discharge operations 2” subroutine ends. The processing then returns to step S176 in the “printing operations” subroutine in FIG. 15, and in step S176, the double-sided printing operations end.

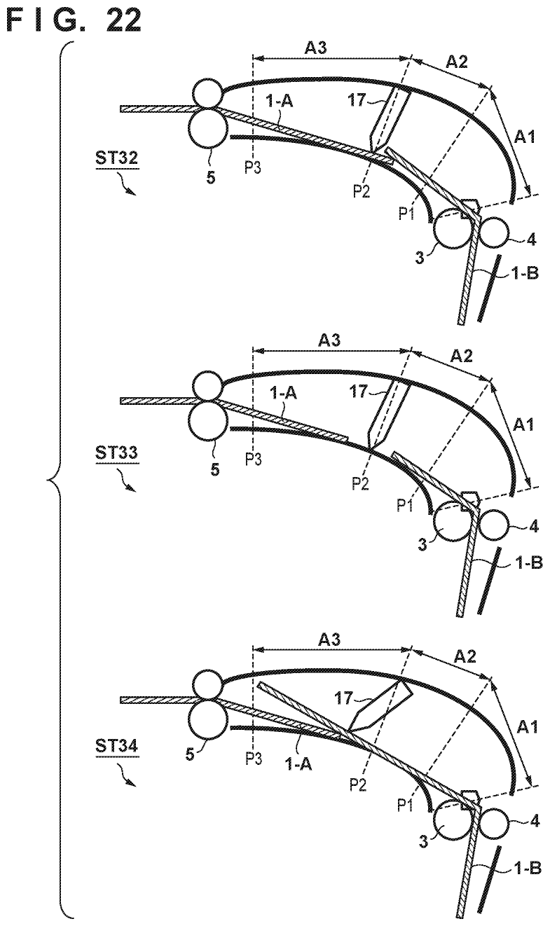

FIGS. 21 and 22 are diagrams illustrating operations for causing the preceding print medium and the following print medium to overlap according to the present embodiment. Operations for creating a state of overlap described in FIGS. 2 to 11, in which the leading end part of the following print medium overlaps the following end part of the preceding print medium, will be described here.

FIGS. 21 and 22 are enlarged views of the area between the feed nip part formed by the feed roller 3 and the feed driven roller 4, and the transport nip part formed by the transport roller 5 and the pinch roller 6. The present embodiment will describe a configuration which includes a print medium holding lever that suppresses lifting of the following end part of the print medium P.

The process through which the print medium is transported by the transport roller 5 and the feed roller 3 will be described as three states in order. The first state, in which operations are performed for the following print medium to follow the preceding print medium, will be described with reference to ST30 and ST31 in FIG. 21. The second state, in which operations are performed for causing the following print medium to overlap the preceding print medium, will be described with reference to ST32 and ST33 in FIG. 22. The third state, in which skew correction operations are performed for the following print medium while maintaining the state of overlap, will be described with reference to ST34 in FIG. 22.

In ST30 in FIG. 21, the feed roller 3 is controlled to transport the following print medium P, and the leading end of the following print medium P is sensed by the print medium sensor 16. A section from the print medium sensor 16 to a position P1 where the following print medium P can be caused to overlap the preceding print medium P is defined as a first section A1. In the first section A1, operations are performed for the leading end of the following print medium P to follow the following end of the preceding print medium P. P1 is determined according to the configuration of the mechanism.

In the first state, there are cases where the operations for following are stopped in the first section A1. As indicated by ST31 in FIG. 21, the operations for causing the following print medium to overlap the preceding print medium are not performed when the leading end of the following print medium P overtakes the following end of the preceding print medium P before P1.

In ST32 in FIG. 22, a section from the aforementioned P1 to a position P2 where a print medium holding lever 17 is provided is defined as a second section A2. Operations for causing the following print medium P to overlap the preceding print medium P are performed in the second section A2.

In the second state, in the second section A2, there are cases where the operations for causing the following print medium to overlap the preceding print medium are stopped. As indicated by ST33 in FIG. 22, the operations for causing the following print medium to overlap the preceding print medium cannot be performed if the leading end of the following print medium P catches up with the following end of the preceding print medium P in the second section A2.

In ST34 in FIG. 22, a section from the aforementioned P2 to P3 is defined as a third section A3. P3 is, for example, the position of the leading end of the following print medium P upon stopping in step S45 in FIG. 13. The print media are transported with the following print medium P overlapping the preceding print medium P until the leading end of the following print medium P reaches P3. In the third section A3, it is determined whether to bring the following print medium P into contact with the transport nip part for cueing while maintaining the state of overlap. In other words, it is determined whether to perform the cueing after the skew correction operations while maintaining the state of overlap, or perform the cueing after the skew correction operations having canceled the state of overlap.

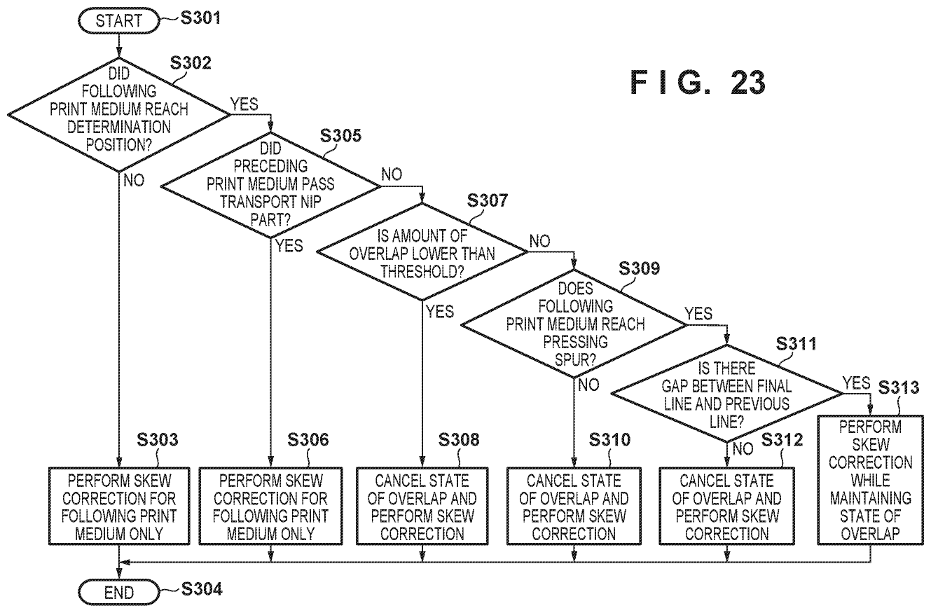

FIG. 23 is a flowchart illustrating skew correction operations for the following print medium according to the present embodiment. The determination as to whether the predetermined condition is satisfied, described in S19 in FIG. 15, will be described in detail here.

Operations will be described for determining whether to (i) perform the skew correction operations by bringing the leading end of the following print medium P into contact with the transport nip part while maintaining the state of overlap between the preceding print medium P and the following print medium P or (ii) perform the skew correction operations by bringing the leading end of the following print medium P into contact with the transport nip part after canceling the state of overlap between the preceding print medium P and the following print medium P.

The processing starts at step S301. In step S302, it is determined whether the leading end of the following print medium P has reached a determination position (FIG. 22: P3 in ST34). If the leading end has not reached the determination position (step S302: NO), it is unclear whether the leading end of the following print medium P will contact the transport nip part by being transported by a predetermined amount, and it is therefore determined that the skew correction operations will be performed for the following print medium only (step S303), after which the determination operations end (step S304). In other words, after the following end of the preceding print medium P passes the transport nip part, only the following print medium P is transported and brought into contact with the transport nip part to perform the skew correction operations, and the cueing is then performed for only the following print medium P.

On the other hand, if the leading end of the following print medium P has reached the determination position P3 (step S302: YES), it is determined whether the following end of the preceding print medium P has passed the transport nip part (step S305). If it is determined that the following end has passed the transport nip part (step S305: YES), the preceding print medium and the following print medium are not overlapping, and it is therefore determined to perform the skew correction operations for only the following print medium (step S306). In other words, the skew correction operations are performed by bringing only the following print medium P into contact with the transport nip part, and the cueing is then performed for only the following print medium P.

On the other hand, if it is determined that the following end of the preceding print medium P has not passed the transport nip part (step S305: NO), it is determined whether the amount of overlap between the following end part of the preceding print medium P and the leading end part of the following print medium P is lower than a threshold (step S307). The position of the following end of the preceding print medium P is updated as the printing operations on the preceding print medium P progress. The position of the leading end of the following print medium P is the aforementioned determination position. In other words, the amount of overlap decreases as the printing operations for the preceding print medium P progress. If the amount of overlap is determined to be lower than the threshold (step S307: YES), a determination is made to cancel the state of overlap and perform the skew correction operations only for the following print medium (step S308). In other words, the following print medium P is not transported with the preceding print medium P after the image forming operations for the preceding print medium P are complete. Specifically, the preceding print medium P is transported by the transport roller 5 being driven by the transport motor 205. However, the feed roller 3 is not driven. The state of overlap is canceled as a result. Furthermore, the skew correction operations are performed by bringing only the following print medium P into contact with the transport nip part, and the cueing is then performed for only the following print medium P.

If the amount of overlap is determined to be at least the threshold (step S307: NO), it is determined whether the following print medium P will reach the spur 12 when the following print medium P is cued (step S309). If it is determined that the following print medium P will not reach the spur 12 (step S309: NO), a determination is made to cancel the state of overlap and perform the skew correction operations only for the following print medium (step S310). In other words, the following print medium P is not transported with the preceding print medium P after the image forming operations for the preceding print medium P are complete. Specifically, the preceding print medium P is transported by the transport roller 5 being driven by the transport motor 205. However, the feed roller 3 is not driven. The state of overlap is canceled as a result. Furthermore, the skew correction operations are performed by bringing only the following print medium P into contact with the transport nip part, and the cueing is then performed for only the following print medium P.

If it is determined that the following print medium P will reach the spur 12 (step S309: YES), it is determined whether there is a gap between the final line of the preceding print medium and the previous line before that final line (step S311). If it is determined that there is no gap (step S311: NO), a determination is made to cancel the state of overlap and perform the skew correction operations only for the following print medium (step S312). If it is determined that there is a gap (step S311: YES), the skew correction operations are performed for the following print medium P while maintaining the state of overlap, after which cueing is performed. In other words, the following print medium P is brought into contact with the transport nip part while remaining overlapped with the preceding print medium P after the image forming operations for the preceding print medium P are complete. Specifically, the transport roller 5 and the feed roller 3 are rotated by driving the first feed motor 206 at the same time as the transport motor 205. After the skew correction operations, cueing is performed with the following print medium P remaining in a state of overlap on the preceding print medium P.

Whether to maintain or cancel the state of overlap between the preceding print medium P and the following print medium P is determined in this manner.

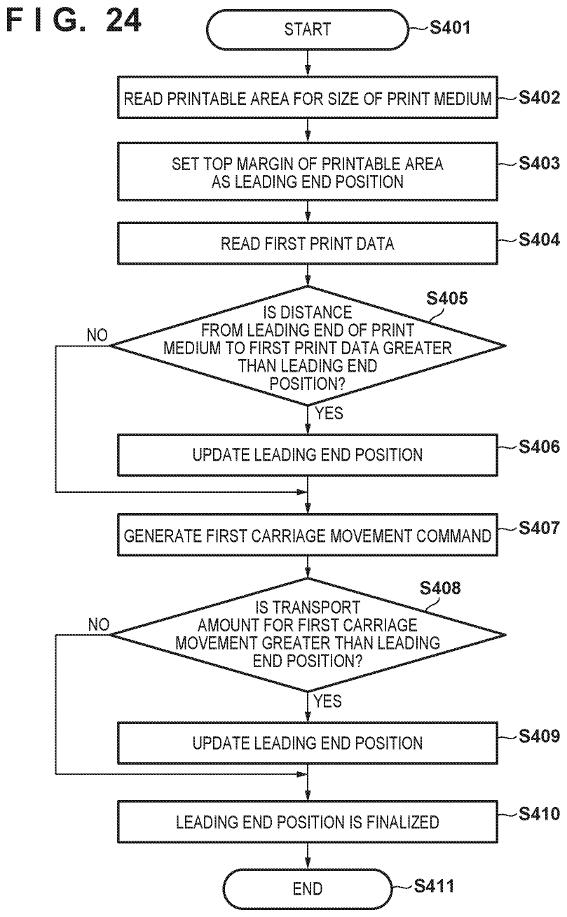

FIG. 24 is a flowchart illustrating a configuration for calculating a leading end position after cueing the following print medium according to the present embodiment.

The processing starts at step S401. In step S402, a printable area for the size of the print medium is read. The uppermost printable position, i.e., the top margin, is identified, and thus the top margin of the printable area is set as the leading end position (step S403). Here, the leading end position is defined as a distance from the transport nip part.

The first print data is then read (step S404). This identifies to which position from the leading end of the print medium the first print data corresponds (detects a non-printing area), and it is therefore determined whether the distance from the leading end of the print medium to the first print data is greater than the leading end position which has been set (step S405). If the distance from the leading end of the print medium to the first print data is greater than the leading end position which has been set (step S405: YES), the leading end position is updated to the distance from the leading end of the print medium to the first print data (step S406). However, if the distance from the leading end of the print medium to the first print data is not greater than the leading end position which has been set (step S405: NO), the processing moves to step S407.

Next, a first carriage movement command is generated (step S407). Then, it is determined whether the transport amount of the print medium for the first carriage movement is greater than the leading end position which has been set (step S408). If the transport amount of the print medium for the first carriage movement is greater than the leading end position which has been set (step S408: YES), the leading end position is updated to the transport amount of the print medium for the first carriage movement (step S409). If the transport amount of the print medium for the first carriage movement is not greater than the leading end position which has been set (step S408: NO), the leading end position is not updated. As described thus far, the leading end position of the following print medium P is finalized (step S410), and the processing then ends (step S411). Whether the following print medium P will reach the spur 12 when the following print medium P is cued can be determined (FIG. 23: step S309) based on the finalized leading end position.

As described thus far, according to the foregoing embodiment, control for causing the leading end part of the following print medium to overlap the following end part of the preceding print medium can be performed regardless of whether the print medium is fed from the paper loading unit or from the second transport path.

The foregoing embodiment described a case where the print medium P is discharged to the exterior of the apparatus by transporting the print medium P downstream in the transport direction using the reversing roller 9, which reverses the transport direction of the print medium. However, the same effects can be achieved even when the configuration includes a discharge path for transporting the print medium P to the exterior of the apparatus between the reversing roller 9 and the discharge roller 10, and a switching member that switches the print medium P between a direction toward the reversing roller 9 and a transport direction toward the discharge path.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-042778, filed Mar. 17, 2022, which is hereby incorporated by reference herein in its entirety.

What is claimed is:

1. A printing apparatus comprising:
a supply unit configured to supply a print medium;
an intermediate roller configured to transport the print medium supplied by the supply unit;
a transport roller configured to transport, in a transport direction, the print medium transported by the intermediate roller;
a printing unit configured to print an image on the print medium transported by the transport roller, downstream from the transport roller;
a reversing path configured to return, to the intermediate roller, the print medium which has been printed onto by the printing unit and which has been reversed front to back; and
a control unit capable of;
first control for causing a second print medium supplied from the supply unit to overlap a first print medium being printed onto by the printing unit, between the intermediate roller and the transport roller, and
second control for causing a second print medium transported from the reversing path to overlap the first print medium being printed onto by the printing unit, between the intermediate roller and the transport roller.

2. The printing apparatus according to claim 1, further comprising:
a discharge path, located downstream from the printing unit in the transport direction, for discharging the print medium onto which an image has been printed,
wherein a reversing roller is disposed in the discharge path, the reversing roller discharging the print medium by rotating in a first direction and transporting the print medium printed onto by the printing unit to the reversing path by rotating in a second direction opposite from the first direction.

3. The printing apparatus according to claim 1, further comprising:
a guide part disposed between the intermediate roller and the transport roller,
wherein the intermediate roller transports the print medium from the reversing path to the guide part.

4. The printing apparatus according to claim 1, further comprising:
a sensor, provided between the intermediate roller and the transport roller, configured to sense an end part of the print medium.

5. The printing apparatus according to claim 1,
wherein the control unit executes a skew correction operation of bringing the second print medium transported from the reversing path into contact with the transport roller while the transport roller is stopped.

6. The printing apparatus according to claim 1,
wherein the control unit determines whether to perform control for causing the second print medium to overlap a following end part of the first print medium based on print data.

7. The printing apparatus according to claim 6,
wherein the print data is a print density in a pre-set printing area.

8. The printing apparatus according to claim 7,
wherein the control unit determines whether to perform control for causing the second print medium to overlap the following end part of the first print medium based on print data in the pre-set area in which the first print medium and the second print medium overlap each other.

9. The printing apparatus according to claim 7,
wherein the control unit determines whether to perform control for causing the second print medium to overlap the following end part of the first print medium by comparing the print density in the pre-set area with a pre-set print density.

10. The printing apparatus according to claim 9,
wherein the control unit determines to perform control for causing the second print medium to overlap the following end part of the first print medium when the print density in the pre-set area is no greater than the pre-set print density.

11. The printing apparatus according to claim 7,
wherein the pre-set printing area is a first area of a leading end part of the print medium and a second area in the following end part of the print medium.

12. The printing apparatus according to claim 3,
wherein the control unit causes the second print medium to catch up to the first print medium by setting a transport speed of the intermediate roller transporting the second print medium to a speed higher than a speed of the transport roller in a state where the first print medium is being transported by the transport roller.

13. The printing apparatus according to claim 2,
wherein the control unit cancels a state of overlap between a following end part of the first print medium and a leading end part of the second print medium by setting a transport speed of the reversing roller in the first direction to a speed higher than a speed of the transport roller transporting the second print medium being printed onto by the printing unit.

14. The printing apparatus according to claim 1,
wherein the control unit detects a leading end position of the second print medium before a printing operation for a final line is performed on the first print medium by the printing unit.

15. The printing apparatus according to claim 1,
wherein when a determination is made to skip control for causing the leading end part of the second print medium to overlap the following end part of the first print medium, the control unit transports the first print medium to a position opposite the printing unit in a state where transport of the second print medium is stopped.

16. A control method for controlling a printing apparatus, the printing apparatus comprising:
a supply unit configured to supply a print medium;
an intermediate roller configured to transport the print medium supplied by the supply unit;
a transport roller configured to transport, in a transport direction, the print medium transported by the intermediate roller;
a printing unit configured to print an image on the print medium transported by the transport roller, downstream from the transport roller; and
a reversing path configured to return, to the intermediate roller, the print medium which has been printed onto by the printing unit and which has been reversed front to back, and
the control method comprising performing control capable of:
causing a second print medium supplied from the supply unit to overlap a first print medium being printed onto by the printing unit, between the intermediate roller and the transport roller, and
causing a second print medium transported from the reversing path to overlap the first print medium being printed onto by the printing unit, between the intermediate roller and the transport roller.

17. The control method for a printing apparatus according to claim 16,
wherein the printing apparatus further includes a discharge path, located downstream from the printing unit in the transport direction, configured to discharge the print medium onto which an image has been printed, and
a reversing roller is disposed in the discharge path, the reversing roller discharging the print medium by rotating in a first direction and transporting the print medium printed onto by the printing unit to the reversing path by rotating in a second direction opposite from the first direction.

18. The control method for a printing apparatus according to claim 16,
wherein the printing apparatus further includes a guide part disposed between the intermediate roller and the transport roller, and
the intermediate roller transports the print medium from the reversing path to the guide part.

19. The control method for a printing apparatus according to claim 16,
wherein the printing apparatus further includes a sensor, provided between the intermediate roller and the transport roller, configured to sense an end part of the print medium.

20. The control method for a printing apparatus according to claim 16,
wherein in the control, a skew correction operation of bringing the second print medium transported from the reversing path into contact with the transport roller while the transport roller is stopped is performed.

21. The control method for a printing apparatus according to claim 16,
wherein in the control, whether to perform control for causing the second print medium to overlap a following end part of the first print medium is determined based on print data.

22. The control method for a printing apparatus according to claim 21,
wherein the print data is a print density in a pre-set printing area.

23. The control method for a printing apparatus according to claim 22,
wherein in the control, whether to perform control for causing the second print medium to overlap the following end part of the first print medium is determined based on print data in the pre-set area in which the first print medium and the second print medium overlap each other.

24. The control method for a printing apparatus according to claim 22,
wherein in the control, whether to perform control for causing the second print medium to overlap the following end part of the first print medium is determined by comparing the print density in the pre-set area with a pre-set print density.

25. The control method for a printing apparatus according to claim 24,
wherein in the control, it is determined that control for causing the second print medium to overlap the following end part of the first print medium is to be performed when the print density in the pre-set area is no greater than the pre-set print density.

26. A non-transitory computer-readable storage medium in which is stored a program that causes a computer to execute the control method for a printing apparatus, the printing apparatus comprising:
a supply unit configured to supply a print medium;
an intermediate roller configured to transport the print medium supplied by the supply unit,
a transport roller configured to transport, in a transport direction, the print medium transported by the intermediate roller;
a printing unit configured to print an image on the print medium transported by the transport roller, downstream from the transport roller; and
a reversing path configured to return, to the intermediate roller, the print medium which has been printed onto by the printing unit and which has been reversed front to back, and
the control method comprising performing control capable of:
causing a second print medium supplied from the supply unit to overlap a first print medium being printed onto by the printing unit, between the intermediate roller and the transport roller, and
causing a second print medium transported from the reversing path to overlap the first print medium being printed onto by the printing unit, between the intermediate roller and the transport roller.
